(19) United States
(12) Patent Application Publication
(10) Pub. No.: US 2025/0156474 A1
(43) Pub. Date: May 15, 2025

(54) Systems and Methods for Generating Multimodal Representations to Communicate Data Uncertainty

(71) Applicant: Salesforce, Inc., San Francisco, CA (US)

(72) Inventors: Chase STOKES, Palo Alto, CA (US); Vidya Raghavan SETLUR, Portola Valley, CA (US); Bridget COGLEY, Columbus, OH (US)

(21) Appl. No.: 19/023,194

(22) Filed: Jan. 15, 2025

Related U.S. Application Data
(63) Continuation of application No. 18/674,750, filed on May 24, 2024.
(60) Provisional application No. 63/538,497, filed on Sep. 14, 2023.

(51) Int. Cl. G06F 16/638; G06F 16/68; G06F 16/683; G06F 16/783

(52) U.S. Cl. CPC G06F 16/638; G06F 16/685; G06F 16/686; G06F 16/7834

(57) ABSTRACT

A computing device receives a user query regarding a dataset that includes variability. The computer device obtains the dataset that includes one or more data fields and data corresponding to the one or more data fields and determines data uncertainty corresponding to the data. The device generates a multi-modal data representation of the data and the data uncertainty, including rendering a data visualization that represents the data and the data uncertainty; generating, according to statistics of the dataset, text content describing the data and the data uncertainty; translating the text content into a speech synthesis markup language to generate an audio narrative of the text content; and synchronizing the data visualization, the text content, and the audio narrative according to a timestamp of the audio narrative. The computing device causes the multi-modal data representation to be presented at a user interface of an electronic device.

### RELATED APPLICATIONS

This application is a continuation of U.S. patent application Ser. No. 18/674,750, filed May 24, 2024, titled “Systems, Methods, and User Interfaces for Communicating Data Uncertainty,” which claims priority to U.S. Provisional Application No. 63/538,497, filed Sep. 14, 2023, entitled “Expressing Uncertainty in Speech, Text, and Visualization,” each of which is hereby incorporated by reference herein in its entirety.

### TECHNICAL FIELD

The disclosed implementations relate generally to representing data, and more specifically, to systems, methods, and user interfaces that enable users to analyze and interpret uncertain data.

### BACKGROUND

Understanding and communicating data uncertainty is crucial for making informed decisions. Communicating data uncertainty can be challenging, especially for audiences with limited statistical expertise. However, accurately communicating uncertainty is critical for decision-making, as it could impact risk assessments.

### SUMMARY

In today's world of data-driven decision-making, effectively communicating the uncertainty inherent to the underlying information is important. Data uncertainty refers to the range of potential outcomes or values, the variability within a dataset, or the potential error in measurements or predictions. While precise data may be ideal for making decisions, such data is uncommon for real-life decisions. Even as uncertainty is recognized as an integral aspect of data interpretation, there are challenges in its effective communication.

One primary challenge is the difficulty in interpreting the information conveyed. When data is uncertain, it can lead to misconceptions or inaccurate conclusions. While experts might understand statistical nuances like confidence intervals or p-values, the lay audience might misread or over-simplify these indicators, leading either to undue confidence or unwarranted skepticism. This, in turn, can greatly impact decision-making in critical domains such as forecasting events in medicine, finance, public policy, or natural disasters.

Another issue with conveying data uncertainty is trust. When the general public or stakeholders encounter uncertain data, there is a risk they might perceive the communication as unreliable, even when such uncertainty is an expected aspect of data analysis, though in some cases indicating uncertainty can increase trust. Furthermore, cognitive biases can influence how people handle information that varies in certainty.

Various modalities have been individually explored to express uncertainty. For example, uncertainty can be expressed visually through quantile dot plots, or linguistically using hedge words and prosody variations. To help people reason about statistics around uncertainty effectively, visualizations use error bars, confidence intervals, and density plots to depict variability, range, and data distribution to convey uncertainty. Written (e.g., text) communication can employ hedge words (e.g., words or phrases such as “somewhat” “might” and “possibly”) to indicate uncertainty in the content. These words can indicate a range of types of uncertainty, e.g., probabilities for future events, matters of opinion, and information that is open to multiple interpretations. In speech communication, uncertainty is often reflected in acoustic characteristics such as pitch and intonation, to convey a speaker's doubt or hesitancy. Multimodal techniques are also useful scaffolds for conveying information uncertainty to users who may be blind or have low vision.

There are tradeoffs on how effective each of these modes is in effectively conveying uncertainty to the intended audience. For example, viewers may not possess sufficient graphical literacy to understand complex visualizations, leading to misconstrued conclusions.

Nuances of uncertainty might not always be captured visually, which can require a verbal or textual explanation. On the other hand, readers might not follow lengthy explanations, resulting in limited comprehension or missing some of the information. The transient nature of speech means that the information conveyed in an utterance cannot be revisited with the same ease as text or visualization.

While speech, text, and visualization each offer specific strategies to communicate data uncertainty, their efficacy tends to be dependent on the context and the target audience. Optimal data communication strategies might involve combining these modes, taking advantage of their relative strengths, and offsetting their limitations.

Thus, what is needed are improved methods, systems, and user interfaces that can contribute towards a more effective integrated experience for communicating data uncertainty.

Some aspects of the present disclosure include systems and user interfaces for communicating data uncertainty to a user. The disclosed user interfaces facilitate user interaction with data, in ways that better present nuances around data imprecision to the user.

Some implementations of the present disclosure explore the integration of various communication modes for conveying data uncertainty. As disclosed, the techniques focus on combining visual, textual, and speech elements to create a more comprehensive understanding of uncertain data. The present disclosure includes the development and evaluation of two multimodal prototypes (e.g., user interfaces)—one passive and one active—to assess their effectiveness in this context. The prototypes leverage visualization, text descriptions with hedge words, and speech elements to convey uncertainty, demonstrating the potential of multimodal approaches in enhancing data interpretation and decision-making processes. The active prototype additionally leverages interaction with the visual and text modes of information.

As disclosed, in some implementations, the user interface for communicating data uncertainty includes a passive user interface for presenting data uncertainty in a multimodal context. A passive user interface is one that delivers multimodal data without explicit user interaction. A passive user interface offers an integrated presentation of information while minimizing user effort.

As disclosed, in some implementations, the user interface for communicating data uncertainty includes an active user interface for presenting data uncertainty in a multimodal context. An active user interface is one that emphasizes user-driven interaction with multimodal data, enabling probing, modification, and in-depth exploration.

In accordance with some implementations, a method of communicating data uncertainty is performed at a computing device having a display, one or more processors, and memory. The memory stores one or more programs configured for execution by the one or more processors. The method includes, in response to a user query regarding a dataset that includes variability (e.g., data in the dataset comprises a distribution), obtaining a multimodal data representation (e.g., file) of the dataset. The method includes displaying an interactive media playback element (e.g., speech seek bar or a widget) in a first region of a user interface of the computing device. The method includes, in response to receiving a user input via the interactive media playback element (e.g., to initiate playback of the multimodal representation), causing playback of the multimodal data representation on the user interface, including presenting audio content (e.g., an audio narrative) describing data in the multimodal representation; and while (e.g., simultaneously with, concurrently with) presenting the audio content, simultaneously presenting visual content via a visualization (e.g., computer-generated visual content, visualization animation) in a second region of the user interface that is different from the first region. The visual content is timed-synchronized with the audio content. The method includes detecting a user interaction with the interactive media playback element. The method includes, in response to detecting the user interaction, modifying a playback portion (e.g., display) of the multimodal visualization and the audio content that is time-synchronized with the multimodal visualization.

For example, in some implementations, the multimodal data representation is used for presenting data having a data distribution. In some implementations, the multimodal data representation includes information about data uncertainty. In some implementations, the multimodal data representation includes an audio component (e.g., audio mode, a speech mode, or a speech component), a text component (e.g., a text mode, such as a text transcript of the speech component), and a visualization component (e.g., a visualization mode or a visualization animation). Each of the components (e.g., modes) is time-synchronized and linked, creating an integrated interface experience. In some implementations, the data in the dataset (e.g., data in the multimodal presentation) includes uncertainty, or has a distribution. Uncertainty, or data uncertainty, refers to data having a range of potential outcomes or values, variability within a dataset, or potential errors in measurements or predictions).

In accordance with some implementations, a method for generating multimodal data representations is performed at a computing device having a display, one or more processors, and memory. The memory stores one or more programs configured for execution by the one or more processors. The method includes, in response to a user query regarding a dataset that includes variability, obtaining the dataset that includes one or more data fields and data (e.g., data values) corresponding to the one or more data fields. The method includes determining data uncertainty corresponding to the data. The method includes generating a multimodal data representation of the data and the data uncertainty, including: rendering a data visualization that represents the data and the data uncertainty; generating, according to statistics of the dataset, text content describing the data and the data uncertainty; translating the text content into a speech synthesis markup language to generate an audio narrative (e.g., speech, audio content) of the text content; and synchronizing the data visualization, the text content, and the audio narrative according to a timestamp of the audio content. The method includes causing the multimodal data representation to be presented at a user interface of an electronic device. In some implementations, the computing device is the electronic device. In some implementations, the computing device is different from the electronic device.

In accordance with some implementations, a computing device includes a display, one or more processors, and memory coupled to the one or more processors. The memory stores one or more programs configured for execution by the one or more processors. The one or more programs include instructions for performing any of the methods disclosed herein.

In accordance with some implementation, a non-transitory computer readable storage medium stores one or more programs configured for execution by a computing device having a display, one or more processors, and memory. The one or more programs include instructions for performing any of the methods disclosed herein.

Thus methods, systems, and graphical user interfaces are disclosed that allow users to generate and present multimodal data representations that represent data uncertainty.

The disclosed methods, devices, and user interfaces disclosed herein advantageously improve on existing approaches to communicating data uncertainty. Because there is no one-size-fits-all approach for uncertainty communication strategies, and the effectiveness of uncertainty communication is intertwined with user preferences and situational context, the implementation of both a passive and an active interface for communicating data uncertainty caters to different user groups or different settings. As one example, while casual users may appreciate the guided, narrative experience with high-level insights that the passive interface provides, expert users may seek detailed, interactive tools for data exploration that are available with the active interface. As another example, the passive interface may be suited for less serious decisions whereas the active interface may be suited for more serious decisions, as it provides more options for users to further interact with the data,

Furthermore, the disclosed multimodal representations integrate a speech mode (e.g., narrative mode), a visualization mode, and a text mode that are all time-synchronized with one another. This integration affords a richer and more holistic experience than the sum of the individual parts. It also provides different avenues for audiences to grasp the depth and breadth of the information presented. Using the speech mode as an example: Speech as a source of information is useful when a user is not interested in reading the text. Speech, when combined with text, is synergistic as it can improve sentence recognition. Speech also improves comprehension of the data display (e.g., visualization) because the audio narrative enables a user to not only understand the overall message conveyed in the multimodal representation but can also provide instructions on how to read the visualization. Prior findings have shown that visualization and text tend to be more effective for logical decision-making, whereas speech garnered the highest trust. This integrative approach of combining visualization, text and speech improves decision-making and promotes trust.

Note that the various implementations described above can be combined with any other implementations described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the aforementioned systems, methods, and graphical user interfaces, as well as additional systems, methods, and graphical user interfaces that provide data visualization analytics, reference should be made to the Detailed Description of Implementations below, in conjunction with the following drawings in which like reference numerals refer to corresponding parts throughout the figures.

FIG. 1 illustrates a design space for communicating data uncertainty in a multimodal context, in accordance with some implementations.

FIG. 2 illustrates a code snippet for algorithmically determining the spread or thickness of a density plot, in accordance with some implementations.

FIG. 3 illustrates a code snippet for computing quantiles from a model's output and assigning a different color to each quantile, in accordance with some implementations.

FIG. 4 illustrates an example of a dependency parse for a sentence, in accordance with some implementations.

FIG. 5 illustrates a decision tree, in accordance with some implementations.

FIG. 6 illustrates an example code snippet for a text transcript of a speech, in accordance with some implementations.

FIG. 7A illustrates a code snippet for correlating skewness value to skewness magnitude, in accordance with some implementations.

FIG. 7B illustrates a code snippet for incorporating hedge words into natural language templates to generate text descriptions, in accordance with some implementations.

FIG. 8 depicts multimodal components and possible user interactions with passive and active interfaces, in accordance with some implementations.

FIG. 9A illustrates screenshots of a passive interface for presenting multimodal representations, in accordance with some implementations.

FIG. 9B illustrates screenshots of a passive interface for presenting multimodal representations, in accordance with some implementations.

FIGS. 10A to 10M are screenshots illustrating a passive interface for communicating data uncertainty, in accordance with some implementations.

FIGS. 11A to 11L are screenshots illustrating an active interface for communicating data uncertainty, in accordance with some implementations.

FIG. 12 illustrates a snapshot of a Tableau Pulse on sales metrics, in accordance with some implementations.

FIG. 13 is a block diagram of a computing device, in accordance with some implementations.

FIG. 14A-14D provide a flowchart of an example process for communicating data uncertainty, in accordance with some implementations.

FIG. 15A-15C provide a flowchart of an example process for multimodal data representations, in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF IMPLEMENTATIONS

In today's world of data-driven decision-making, effectively communicating the uncertainty inherent to the underlying information is important. Data uncertainty refers to the range of potential outcomes, variability within a dataset, or possible error in measurements or predictions. While precise data may be ideal for making decisions, such data is uncommon in real-life decisions. Communicating uncertainty can allow for a better understanding of the true state of the data.

The complexity of uncertain data necessitates the careful presentation and communication of information to the target audience. Multimodal data representation offers an avenue to capture the multifaceted nature of this data, integrating text, visuals, and auditory signals. This integration may afford a richer and more holistic experience, providing different avenues for audiences to grasp the depth and breadth of the information presented.

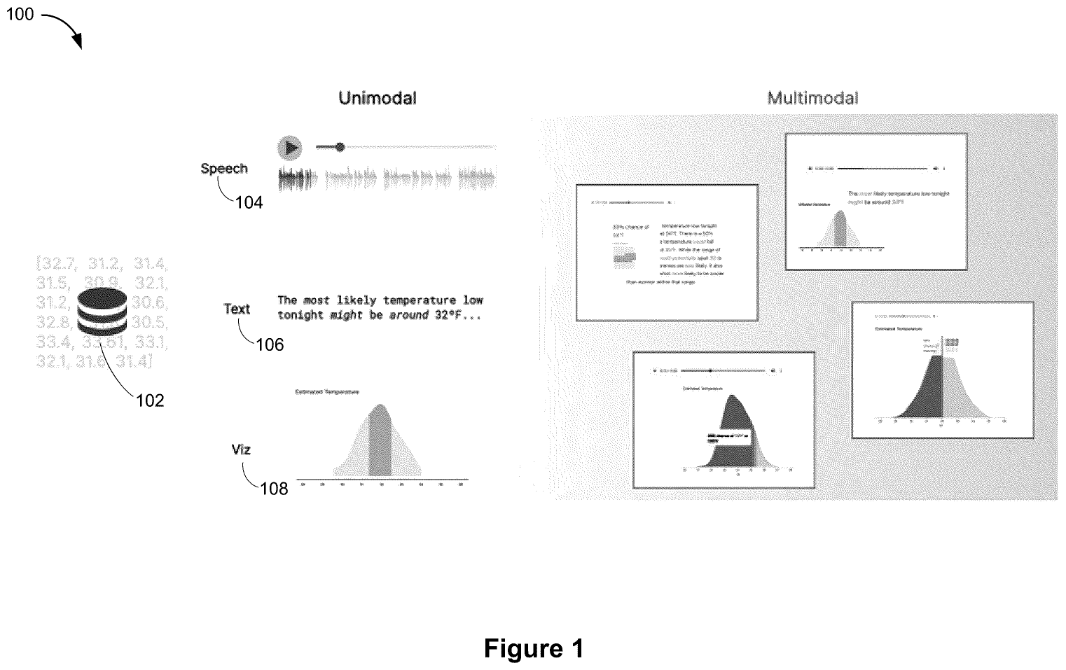

FIG. 1 illustrates a design space 100 for communicating data uncertainty in a multimodal context, in accordance with some implementations. Data 102 can be depicted through diverse modes such as speech 104 (e.g., a speech mode or speech component), text 106 (e.g., a text mode or text component), and visualization 108 (e.g., a visualization mode or visualization component). These modes can also be combined to create multimodal representations, which can provide insights or experiences beyond what a single mode can offer. Some implementations of the present disclosure examine how these different modes of communication express data uncertainty for decision-making. Some implementations explore how the different modes and their variations influence decision-making processes.

While the advantages of multimodal data representation are clear, the path to its effective implementation remains challenging. Different modes of data representation can present different kinds of information with tradeoffs in terms of both presentation of information and effectiveness in its communication. For example, speech information contains signals beyond what text alone can provide—the pitch and duration of certain words can communicate nuances that text cannot. In some instances, visualizations provide more information than can be concisely represented in text or speech formats.

### Generating Multimodal Representations That Convey Data Uncertainty

Some implementations disclose a method and device for generating multimodal data representations.

In some implementations, a computing device (e.g., computing device 1300) generates a multimodal data representation in response to a user query regarding a dataset that includes variability. The dataset can include data field(s) and data (e.g., data values) of the data field(s). The computing device can compute data uncertainty using statistical measures. The mathematics behind statistical measures for computing data uncertainty generally involve concepts such as standard deviation, percentile ranges, Bayesian methods, and entropy.

Standard deviation (σ) measures the amount of variation or dispersion in a set of values. Standard deviation can be calculated as the square root of the variance, as follows:

$$σ = \sqrt{\frac{1}{N} {\sum }_{i = 1}^{N} {( {x}_{i} - μ )}^{2}}$$

where μ is the mean and N is the number of data points.

Percentile Ranges involve estimating the range within which a parameter will fall in the given distribution. For non-normal distributions, the percentile range is calculated by sorting the data in ascending order and finding the value below which a certain percentage of the data falls. The rank (R) of the percentile for the p^{th} percentile in a dataset of n values is computed as follows:

$$R = \frac{p}{100} \times ( n + 1 )$$

For ranks that are not whole numbers, the values of the closest ranks are averaged.

For normal distributions, this process is replaced with a confidence interval (CI) calculation. CI is computed as:

$$CI = μ \pm z \times \frac{σ}{\sqrt{N}}$$

where z is the z-score corresponding to the desired confidence level.

Bayesian methods involve updating the probability estimate for a hypothesis as more evidence or information becomes available. The Bayes' theorem is expressed as:

$$P ( H \vert E ) = \frac{P ( E \vert H ) \times P ( H )}{P ( E )}$$

where P (H|E) is the probability of the hypothesis H given the evidence E.

Entropy measures the uncertainty in a random variable. The formula is:

$$H ( x ) = - {\sum }_{i = 1}^{N} P ( {x}_{i} ) log P ( {x}_{i} )$$

where P(xᵢ) is the probability of each category.

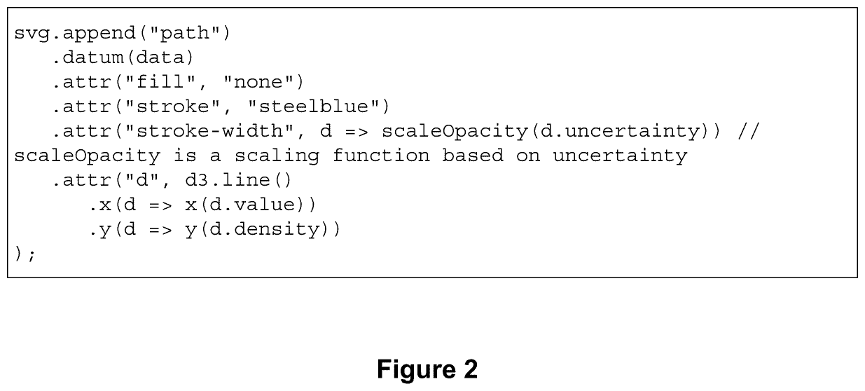

In some implementations, the computing device algorithmically determines the spread or thickness of a density plot. In some implementations, the computing device adjusts opacity and stroke-width based on the data uncertainty level. FIG. 2 illustrates a D3 code snippet for appending a path element to a scalable vector graphics (SVG) markup language, and using a line generator to create a “path” based on “data,” where the “stroke-width” and opacity are adjusted based on the data uncertainty level.

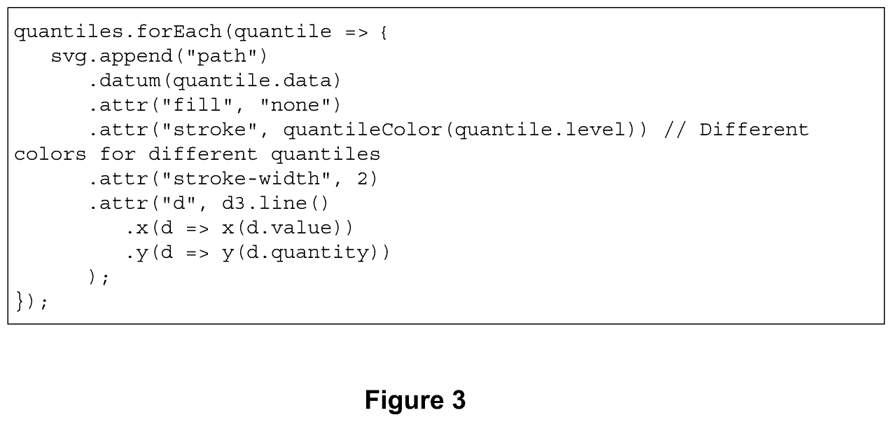

In some implementations, the computing device computes the quantiles from the model's output, where each line or area represents a different quantile, with styling or color indicating the level of certainty. FIG. 3 illustrates a D3 code snippet for computing quantiles from the model's output and assigning a different color to each quantile, in accordance with some implementations.

In some implementations, the computing device detects data uncertainty in text using dependency parsing and decision tree classifier.

For example, the computing device detects uncertainty in text by applying dependency parsing for identifying and tokenizing hedge words and phrases (e.g., words such as “maybe,” “approximately,” and “it seems”) that indicate uncertainty.

Dependency parsing generates a parse tree that captures the relationship between words in the text. Each dependency parse comprises a head word and its child word.

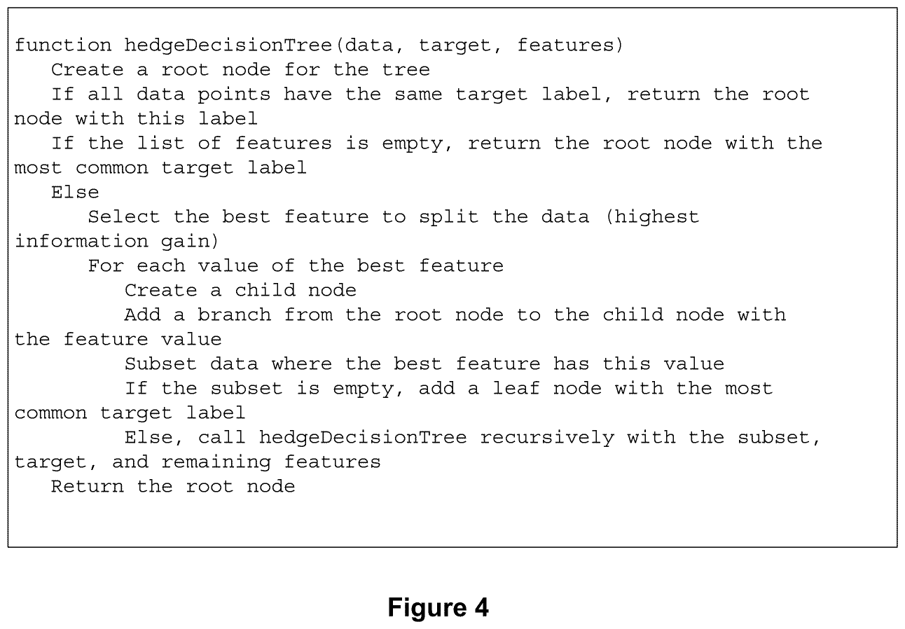

FIG. 4 illustrates an example of a dependency parse for the sentence, “The most likely temperature low tonight is 34 degrees Fahrenheit,” which contains the hedge phrase “most likely.”

Table 1 below shows the following descriptions for the various dependency relations:

TABLE 1
Descriptions for Various Dependency Relations

| | Description |
|---|---|
| Clausal Argument Relations | |
| NSUBJ | Nominal subject |
| Nominal Modifier Relations | |
| ADVMOD | Adverbial modifier |
| AMOD | Adjectival modifier |
| NPADVMOD | Noun phrase as adverbial modifier |
| NUMMOD | Numeric modifier |
| DET | Determiner |
| CASE | Prepositions, postpositions, case markers |
| Other Notable Relations | |
| AUX | Auxiliary |
| CONJ | Conjunct |
| CC | Coordinating conjunction |

A set of features containing these part-of-speech (POS) and dependency relation tags are then extracted based on the location of the dependency term to train a decision tree for recognizing text uncertainty in the form of hedge phrases.

Some implementations employ a decision tree classifier as the features that influence the decision are used to generate rules and the decision made by the classifier tends to be easy to interpret.

The inputs to the decision tree classifier are the features from the dependency parse (as shown in the above example FIG. 3) and the classifier produces an output of TRUE or FALSE (i.e., whether the sentence contains a hedge phrase(s) or not. If the output is TRUE, the classifier also specifies the relevant tokens that are marked as hedge words using the features from the dependency parser. For example, for the above example, the decision tree classifier returns TRUE with a <key><value> pair of “advod”: “most likely”.

The decision tree classifier uses a top-down greedy approach to build a decision tree given the parsed sentence, comprising a root node, internal node, and leaf nodes representing the various hierarchies of the tree, where each node represents a feature, each branch represents a decision rule, and each leaf node represents an outcome.

In some implementations, the computing device employs an Iterative Dichotomiser (ID3) algorithm to construct the decision tree for this classification task. Details of the ID3 algorithm are described in Quinlan, J. R. (1986), Induction of decision trees. Machine Learning, 1(1), 81-106, which is incorporated by reference herein in its entirety. The decision tree construction involves evaluating the best feature to split the data at every step by using the concepts of entropy (a measure of disorder or unpredictability) and information gain (reduction in entropy).

Using the ID3 algorithm in the context of classifying whether a sentence contains a hedge word like “most likely” can be illustrated by treating the classification task as a decision tree problem. In this case, the goal is to decide whether a given sentence contains hedge words, which are words or phrases used to express uncertainty or probability rather than certainty.

In some implementations, the overall algorithm is described as follows:
Step 1. Set up Training Dataset: Start with an initial training set of sentences that either contain hedge words used to describe uncertainty (e.g., “most likely,” “probably,” “might be”) or do not. In some implementations, each sentence is labeled (e.g., manually or automatically, by the computing device) as either containing or not containing hedge words.
Step 2. Calculate Entropy for Target: The target variable here is the binary classification: does the sentence contain a hedge word or not? The entropy is calculated for this target variable across the entire dataset.
Step 3. Calculate Information Gain for Each Feature: Features are specific words, phrases, or other linguistic indicators that might correlate with the presence of hedge words. For each feature (e.g., presence of “likely”), calculate the information gain relative to the target variable.
Step 4. Choose Feature with Maximum Information Gain: The algorithm selects the feature that most effectively splits the sentences into those with and without hedge words. For instance, the algorithm identifies that the presence of the word “likely” is the most informative.
Step 5. Split Data Based on the Selected Feature: The dataset is split into subsets where sentences either contain or do not contain the chosen feature, like “likely.”
Step 6. Repeat Recursively for Each Branch: The process is repeated for each subset, creating further splits based on other features. This step is required because a sentence might contain multiple hedge words and phrases beyond “likely” for example.
Step 7. Creation of Leaf Nodes: The process stops when either all sentences in a subset contain hedge words, none contain them, or other stopping criteria are met. Each final subset is assigned a classification based on the majority label of the sentences in that subset.

FIG. 4 illustrates an example pseudo-code outlining the above process, in accordance with some implementations.

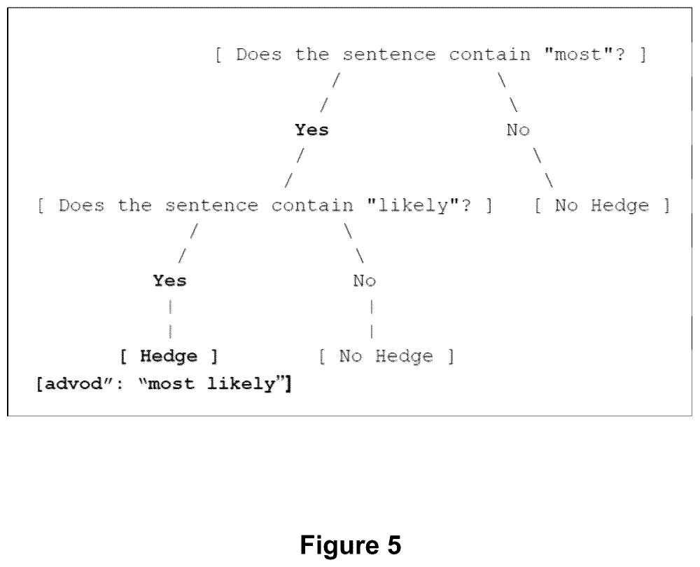

FIG. 5 illustrates a decision tree, in accordance with some implementations. The hedgeDecisionTree classifier begins at the root and moves down based on the presence of the words “most” and “likely.” The leaves of the tree (“Hedge” or “No Hedge”) provide the final classification, with the bolded leaf node containing the final outcome [Hedge] [advod”: “most likely”].

Speech module (e.g., speech module 1330). In some implementations, the computing device incorporates data uncertainty as speech parameters in Speech Synthesis Markup Language (SSML).

Uncertainty can be programmatically reflected using the SSML markup language by adjusting prosody attributes and incorporating hedge words.

In some implementations, for sections in the text with higher uncertainty, the computing device alters the prosody element in SSML to modify speech rate, pitch, and volume.

In some implementations, the computing device slows down the speech rate and lowers the volume for uncertain parts, as these changes in prosody can imply caution or uncertainty.

In some implementations, the computing device slightly varies the pitch to make the speech sound less assertive. In some implementations, hedge words or phrases such as “possibly”, “perhaps”, “it seems”, or “approximately” are inserted in the text where uncertainty is identified.

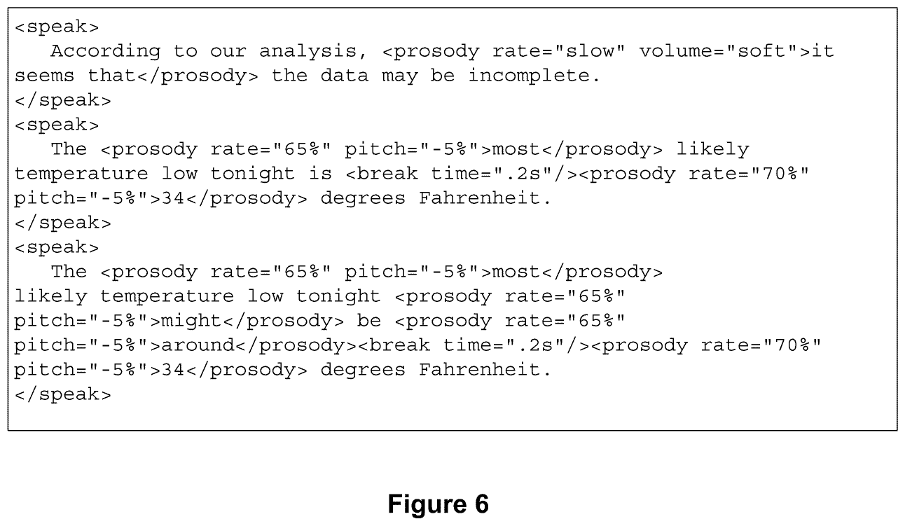

FIG. 6 illustrates an example code snippet for a text transcript of a speech, showing how prosody attributes can be adjusted and hedge words can be included to communicate data uncertainty, in accordance with some implementations.

Text module (e.g., text module 1328). In some implementations, the computing device applies one or more natural language templates to generate the text content. The natural language templates can be populated with hedge words and summary statistics from the dataset. Data uncertainty can be incorporated in text by applying similar NLP techniques described in the previous section.

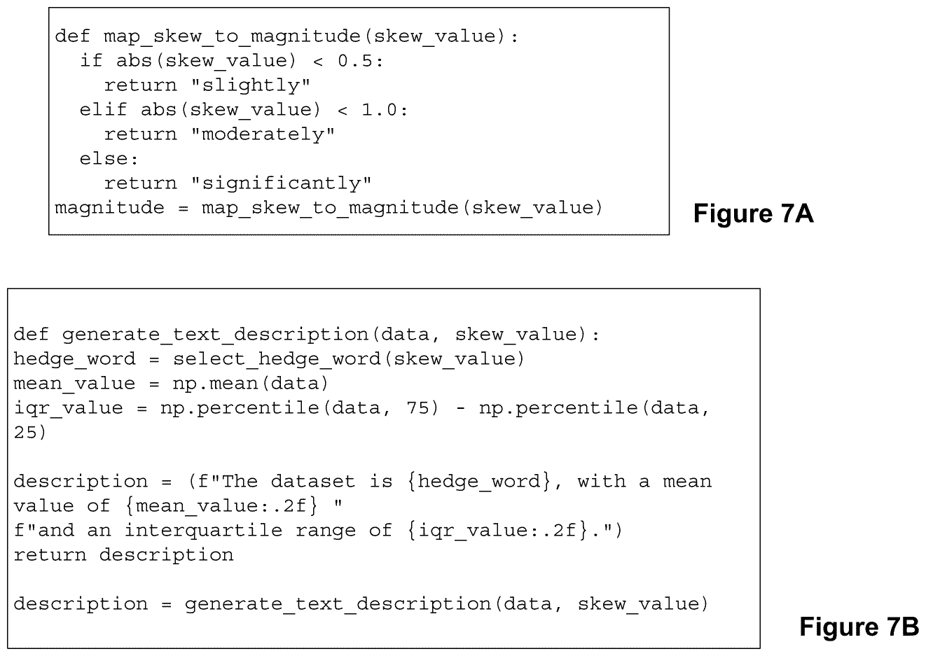

In some implementations, hedge words can be algorithmically computed based on the variability and distribution of the data using the following steps:
Step 1. Compute summary statistics: Calculate key statistics such as mean, median, range, interquartile range (IQR), and skewness of the dataset.
Step 2. Assess the distribution shape, variability, and spread of the data: This includes identifying whether the data follows a normal distribution or is skewed.
Step 3. Map data characteristics to hedge words: The skewness value can be used to determine the direction (e.g., positive or negative) and magnitude (e.g., slight, moderate, significant) of skewness. This helps in choosing appropriate hedge words. Higher variability or wider ranges can correspond to stronger hedge words (e.g., “might”, “could”, “possibly”) indicating greater uncertainty, whereas lower variability or narrower ranges use weaker hedge words (e.g., “likely”, “probably”). FIG. 7A illustrates a code snippet for correlating skewness value to skewness magnitude, in accordance with some implementations.
Step 4. Incorporate the hedge words into natural language templates to generate the text descriptions. FIG. 7B illustrates a code snippet for this process, in accordance with some implementations.

In some implementations, the computing device encodes the text with a font color that is representative of the level of certainty. For instance, a standard black color is used to represent certain information, while the hex code “#757575” is used to denote increasing levels of uncertainty. In some implementations, the computing device italicizes hedge words and renders them with a blur effect of 0.5 px so that they appear visually “fainter” compared to more certain information. Additional information about the uncertainty is provided in tooltips that appear when a user hovers over the text.

### Passive and Active Interfaces (e.g., Prototypes) for Communicating Data Uncertainty

Some implementations disclose a passive interface and an active interface for presenting data uncertainty. A passive interface delivers multimodal data without explicit user interaction, while an active interface emphasizes user-driven interaction, enabling probing, modification, and in-depth exploration. Passive and active interfaces cater to different forms of data consumption in a multimodal context.

In some implementations, each interface—whether passive or active—creates a holistic and in-depth multimodal experience by incorporating a combination of (e.g., at least two of) speech, text, and visualization. For example, rather than independently operating representations, each mode was linked to the others, creating an integrated interface experience.

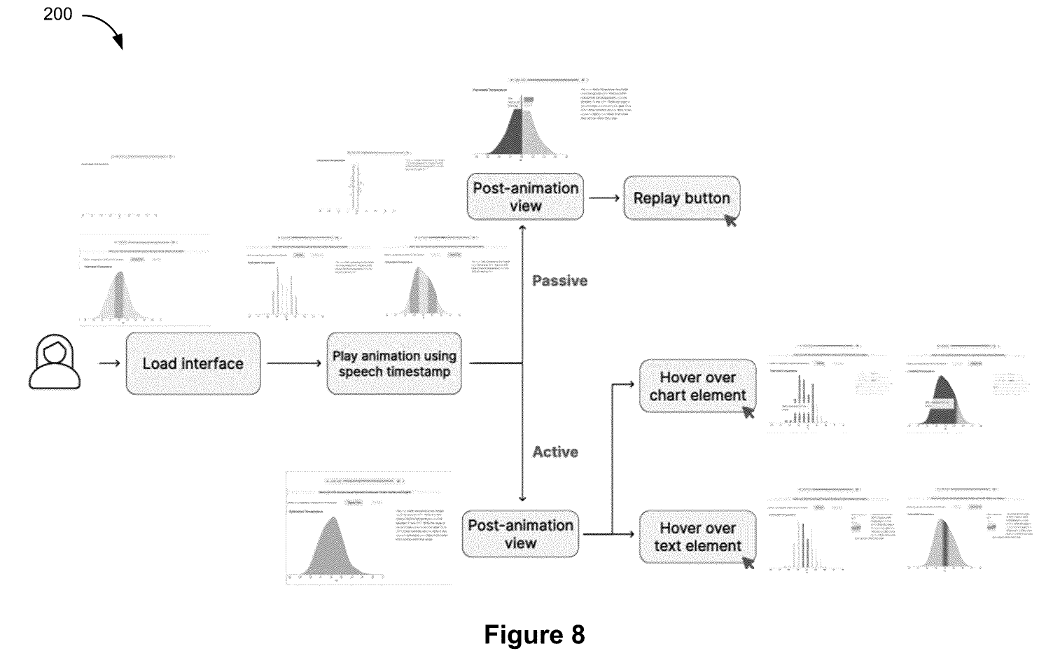

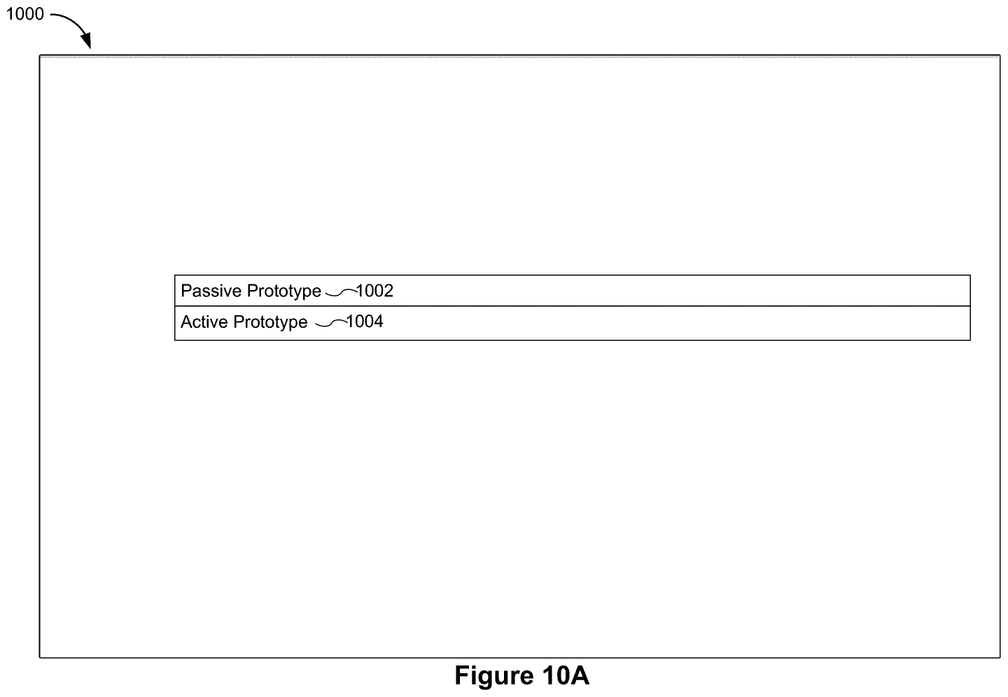

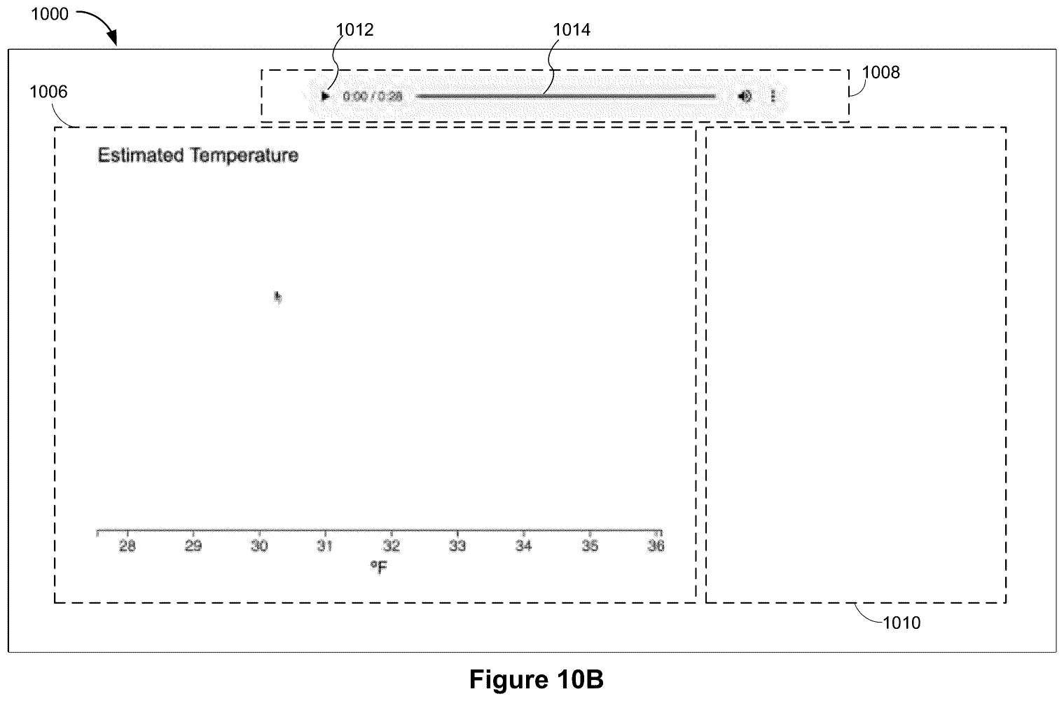

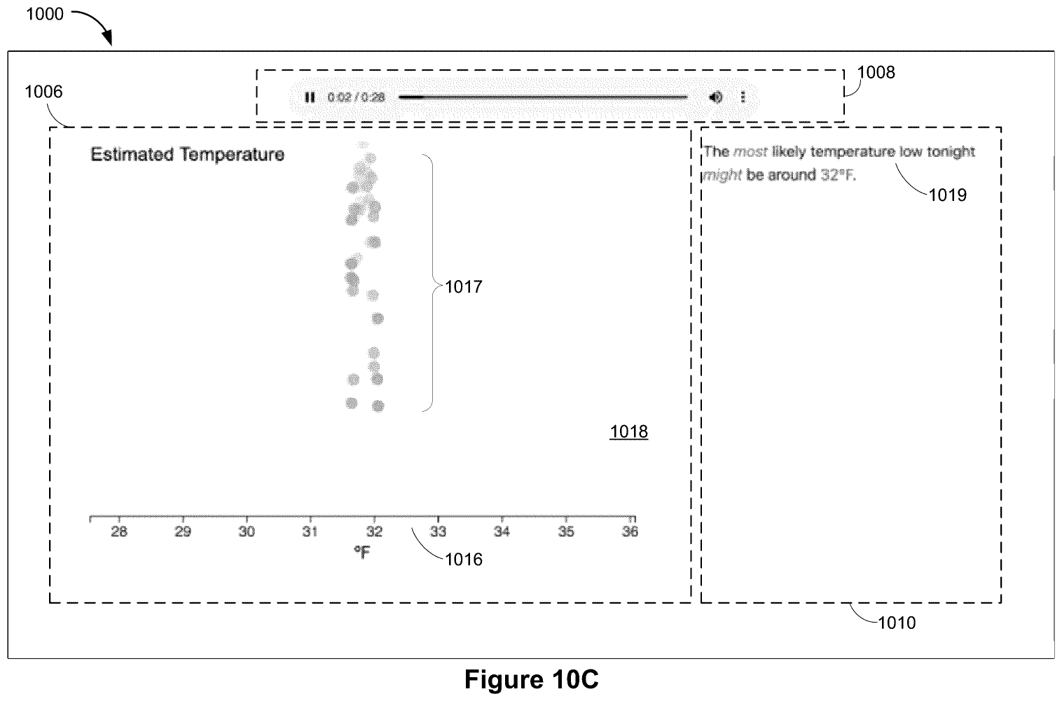

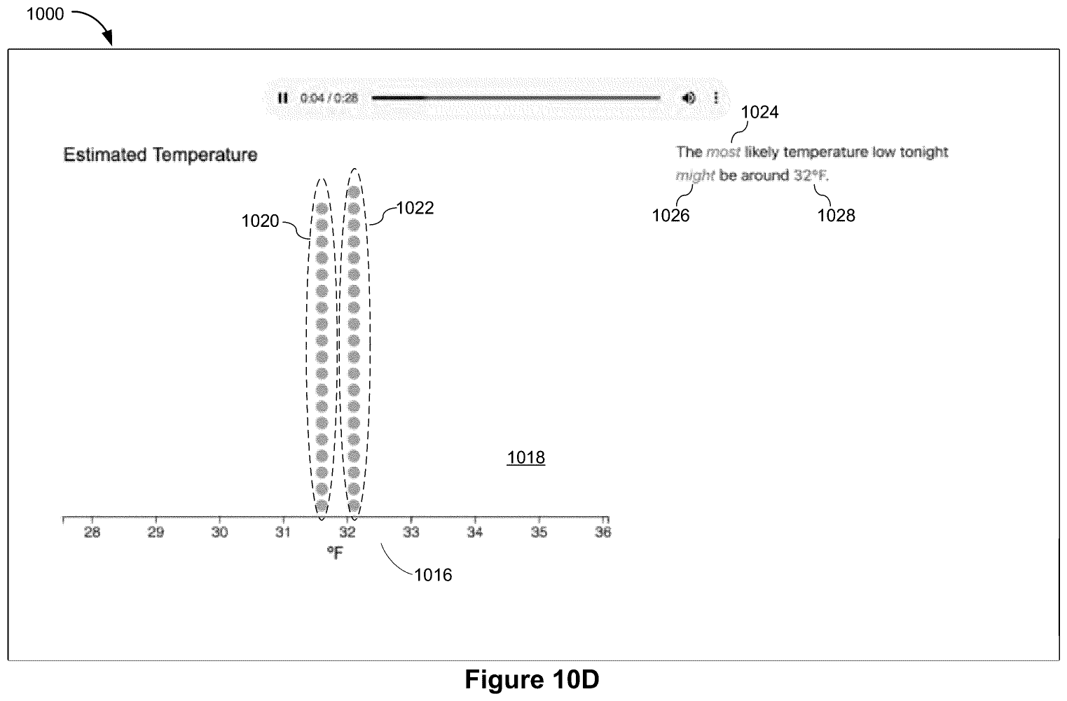

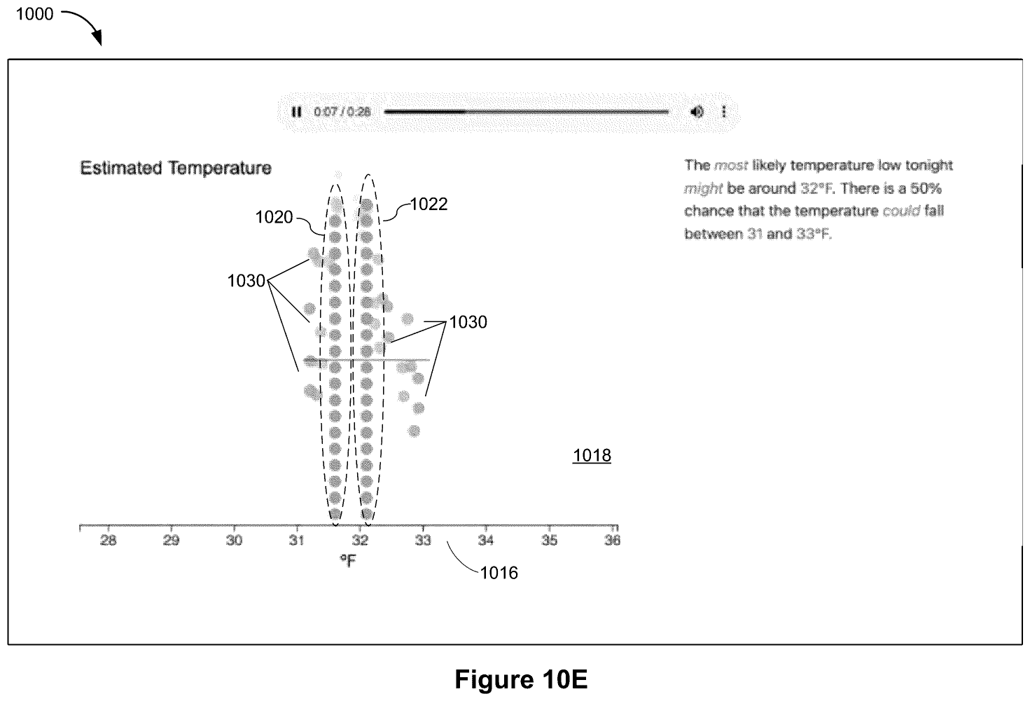

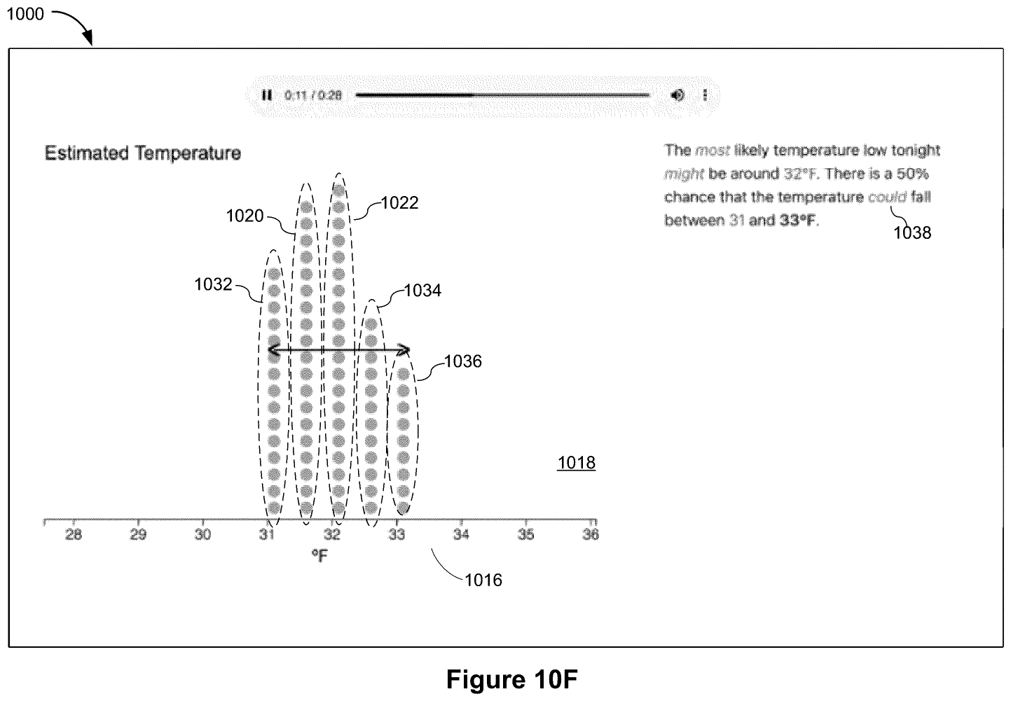

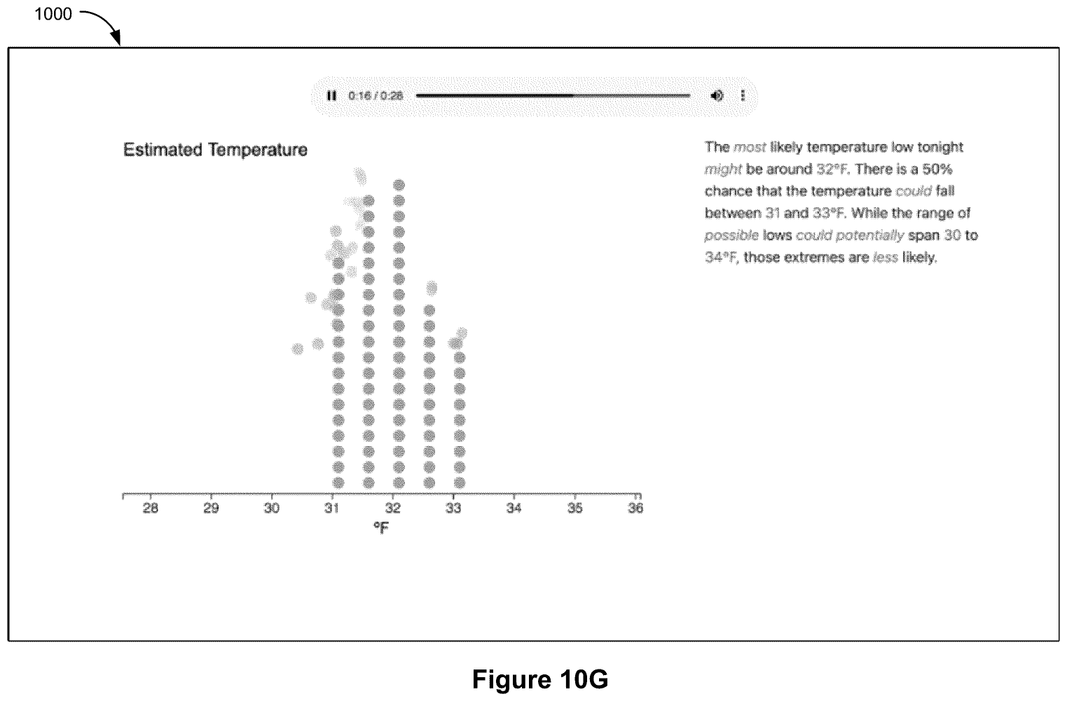

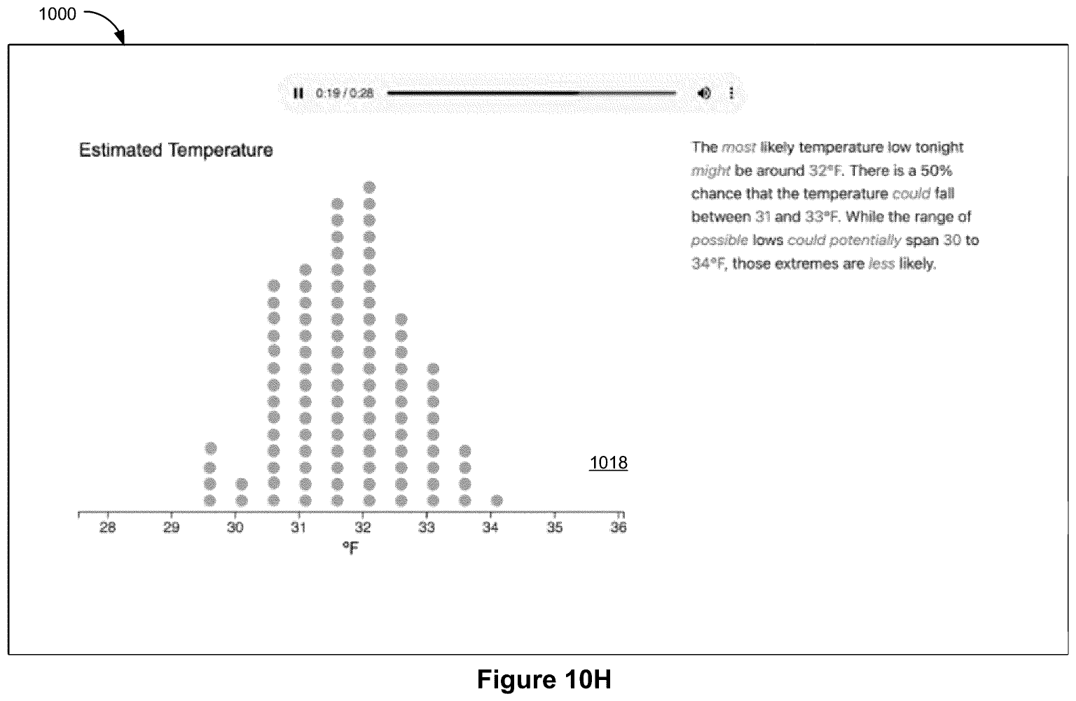

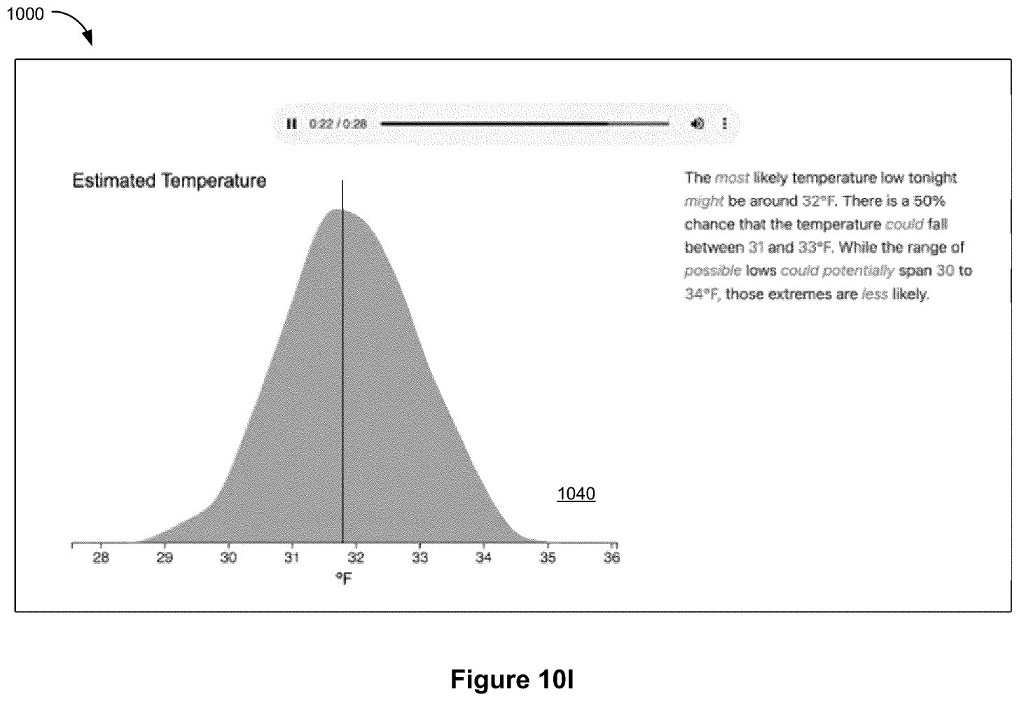

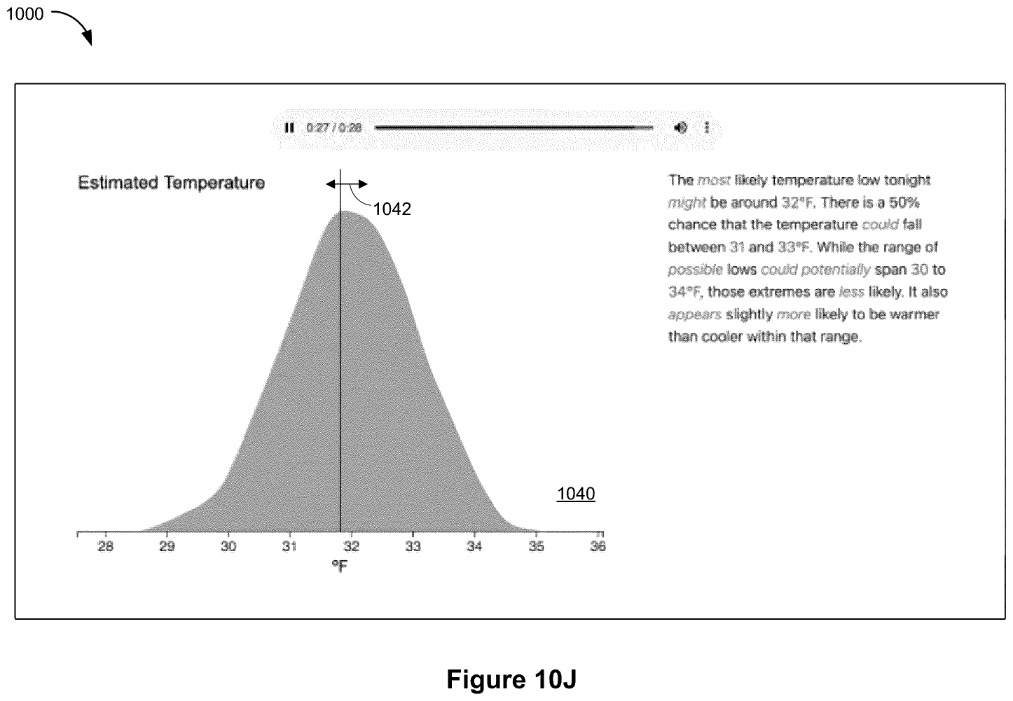

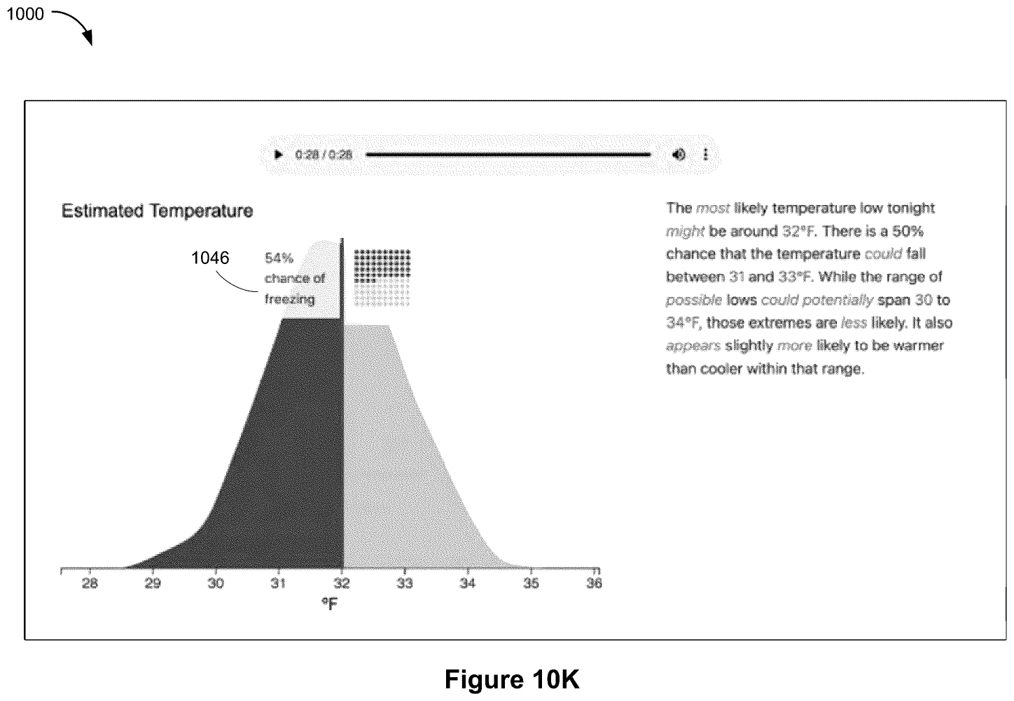

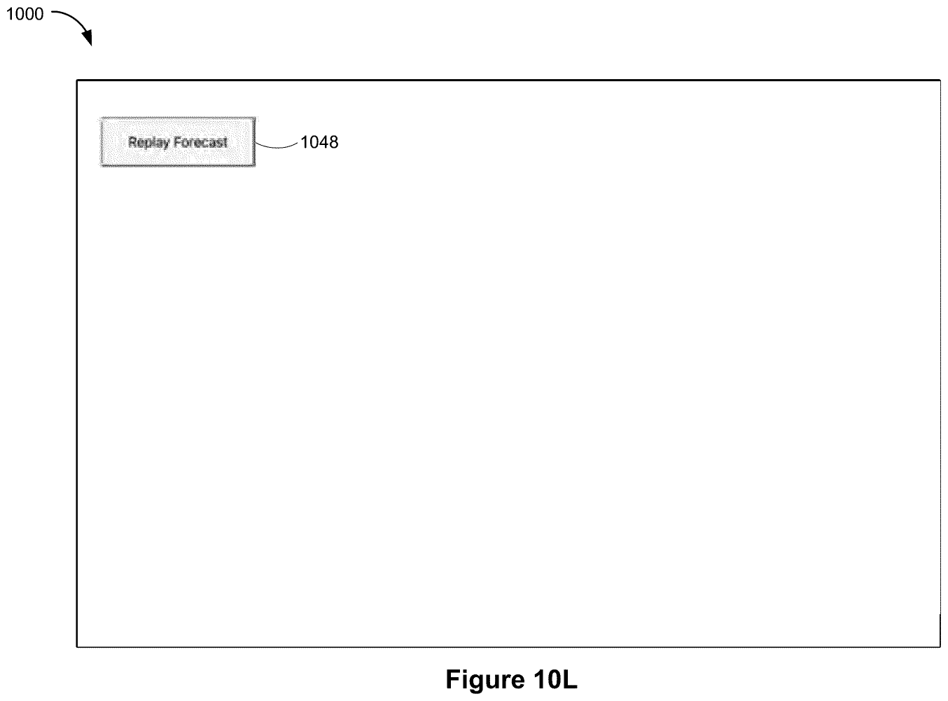

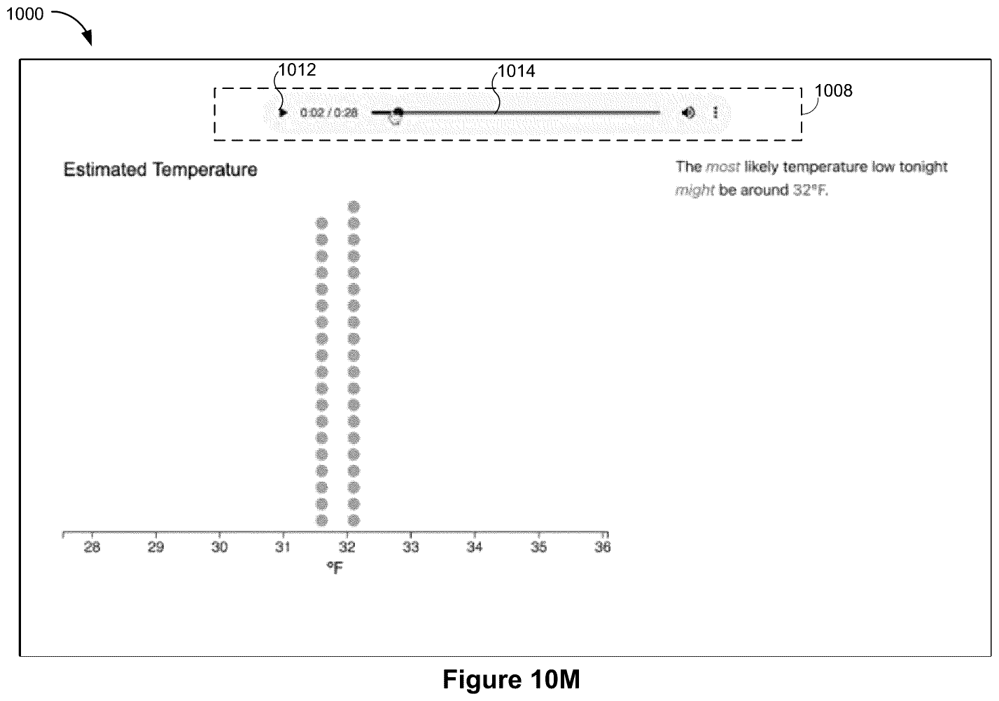

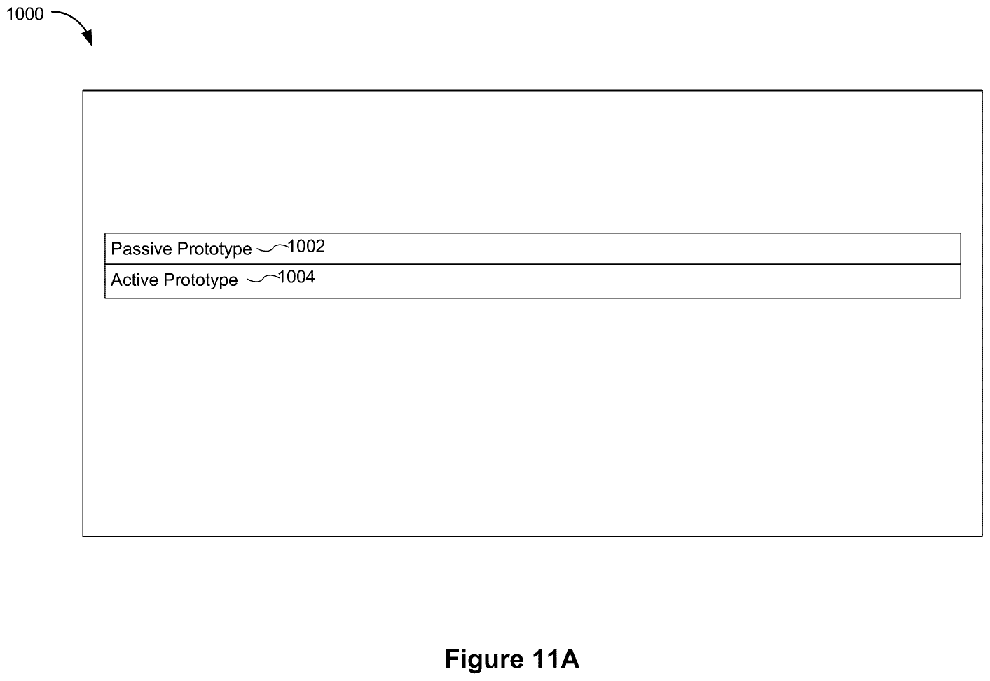

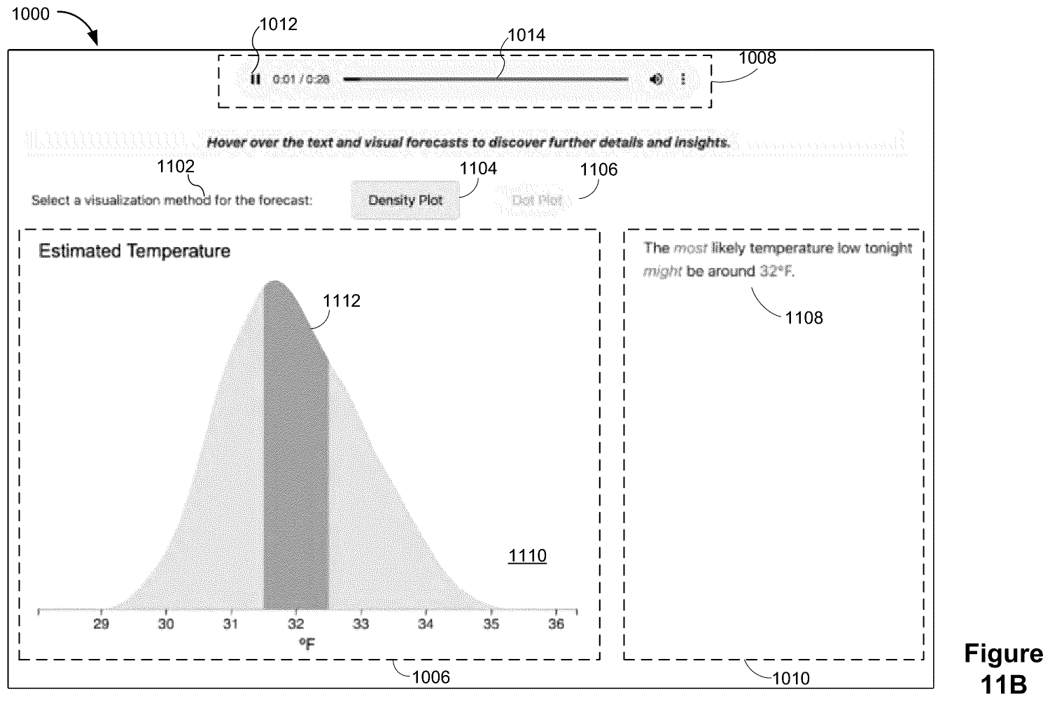

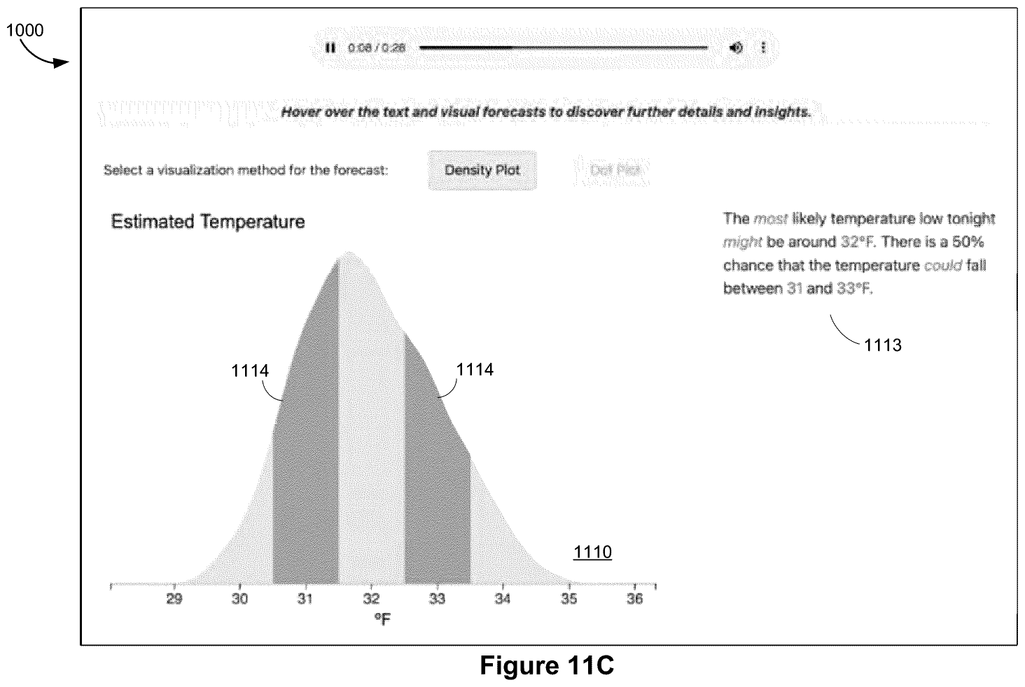

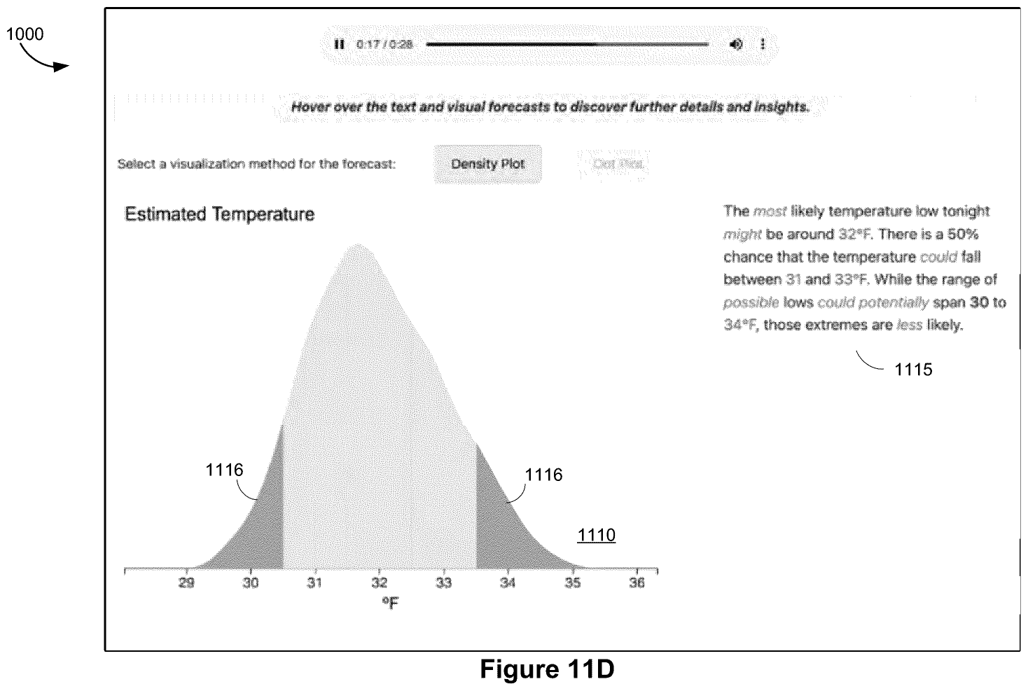

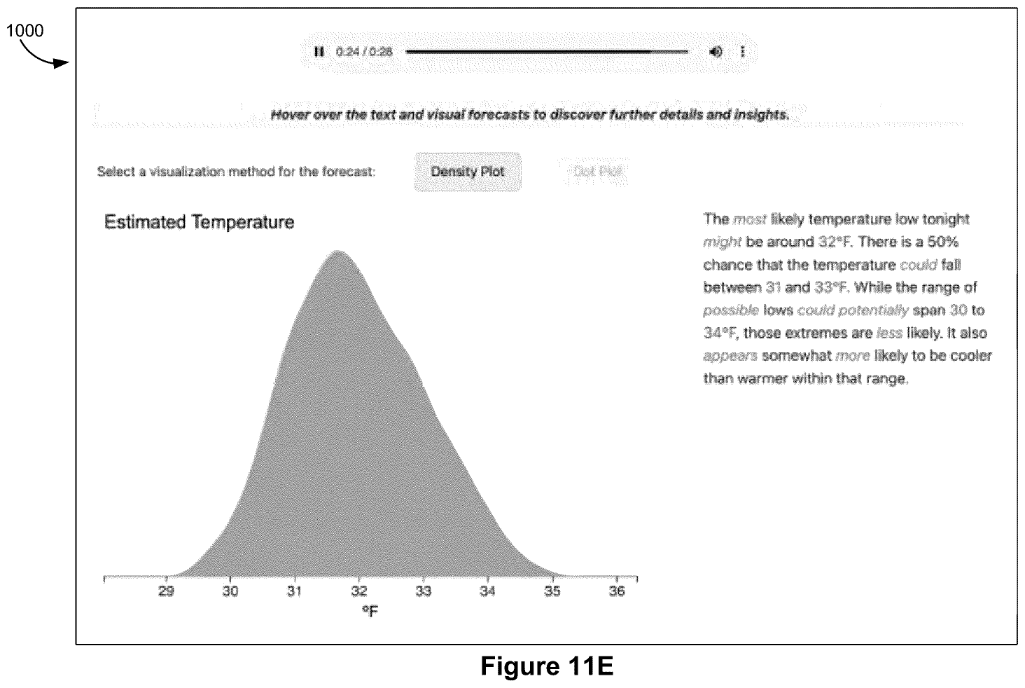

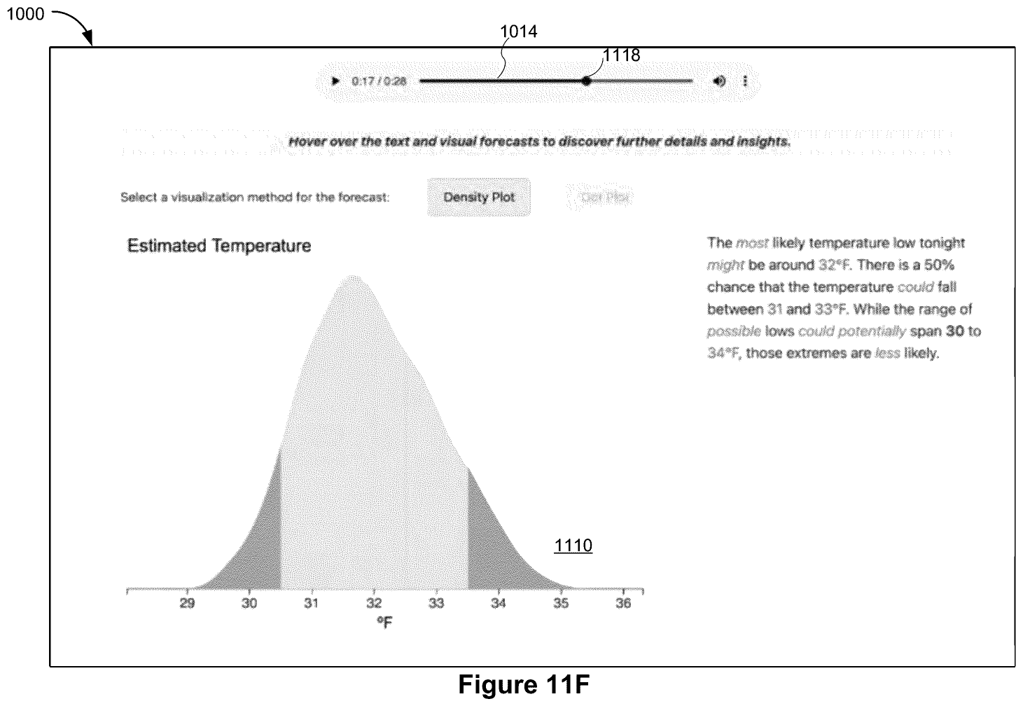

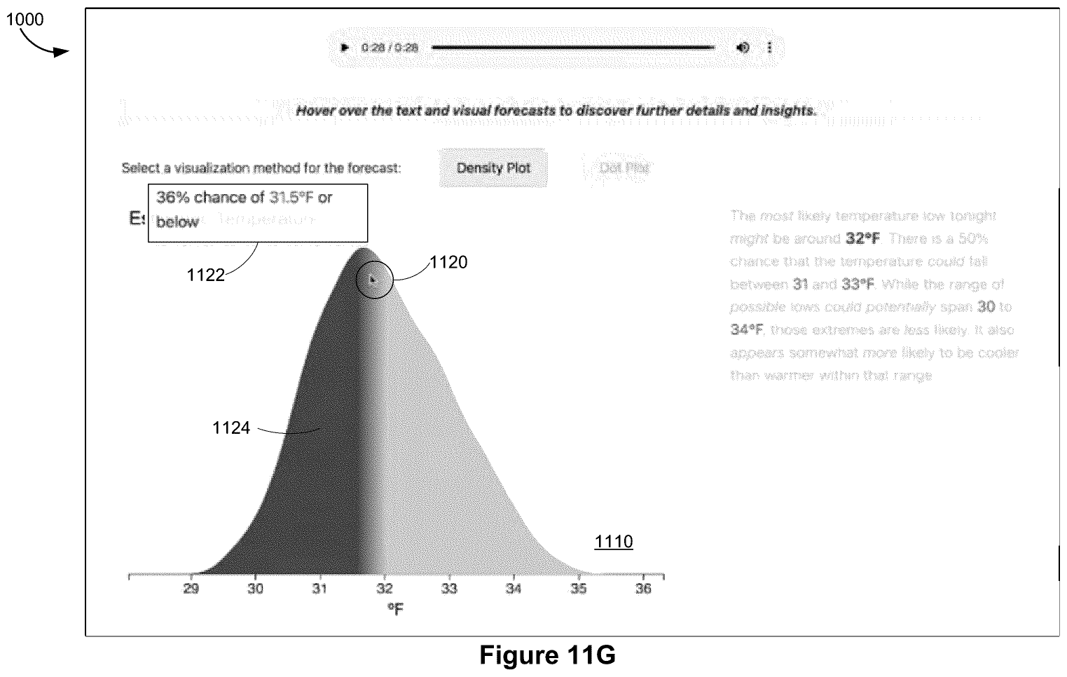

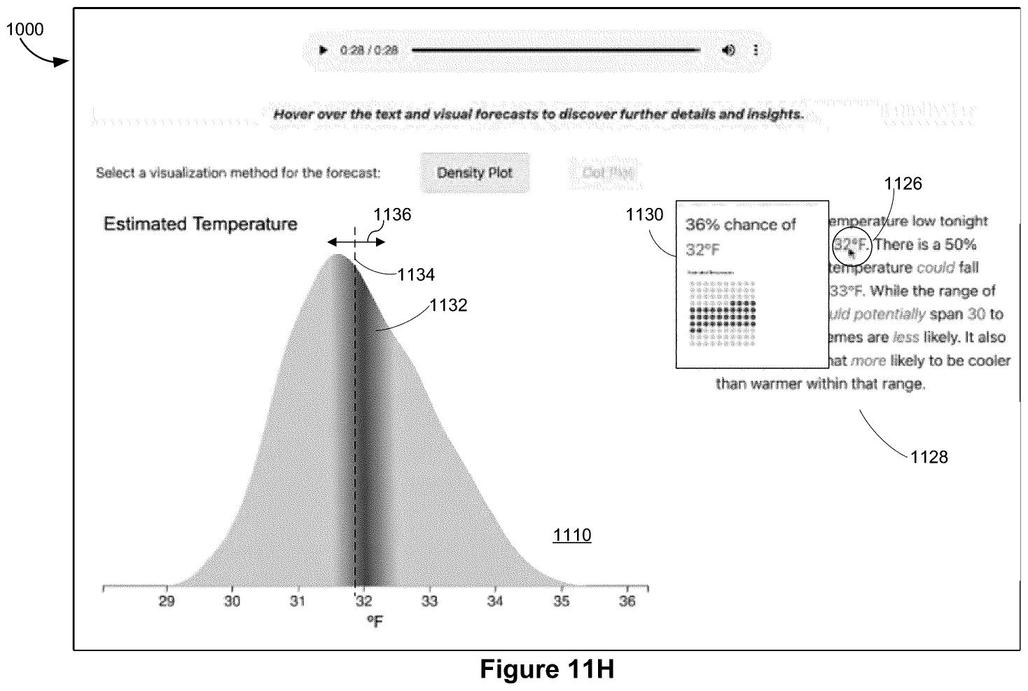

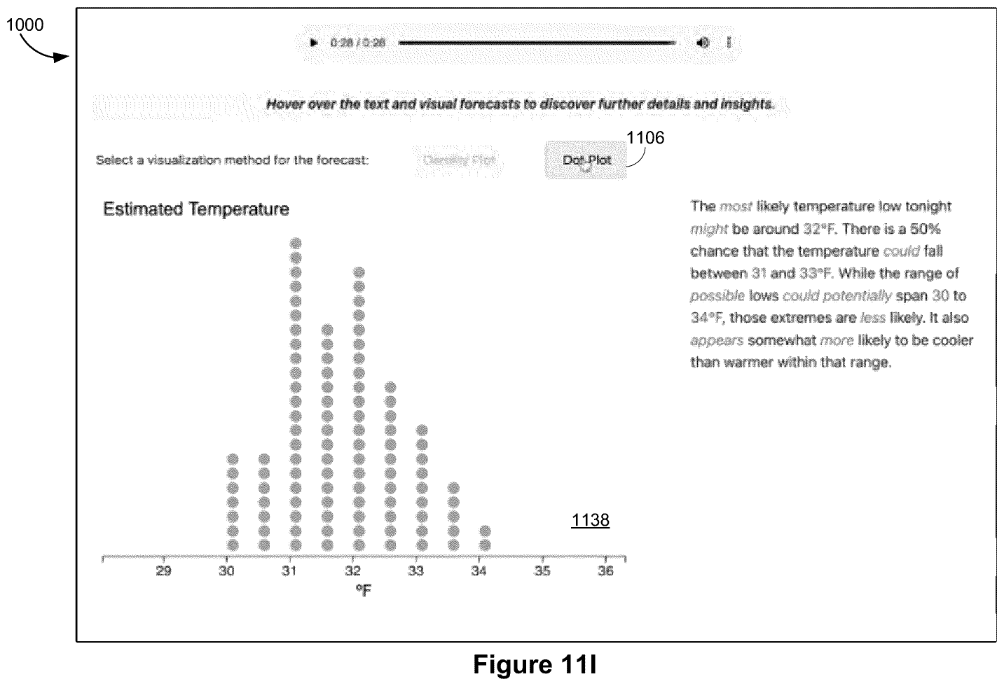

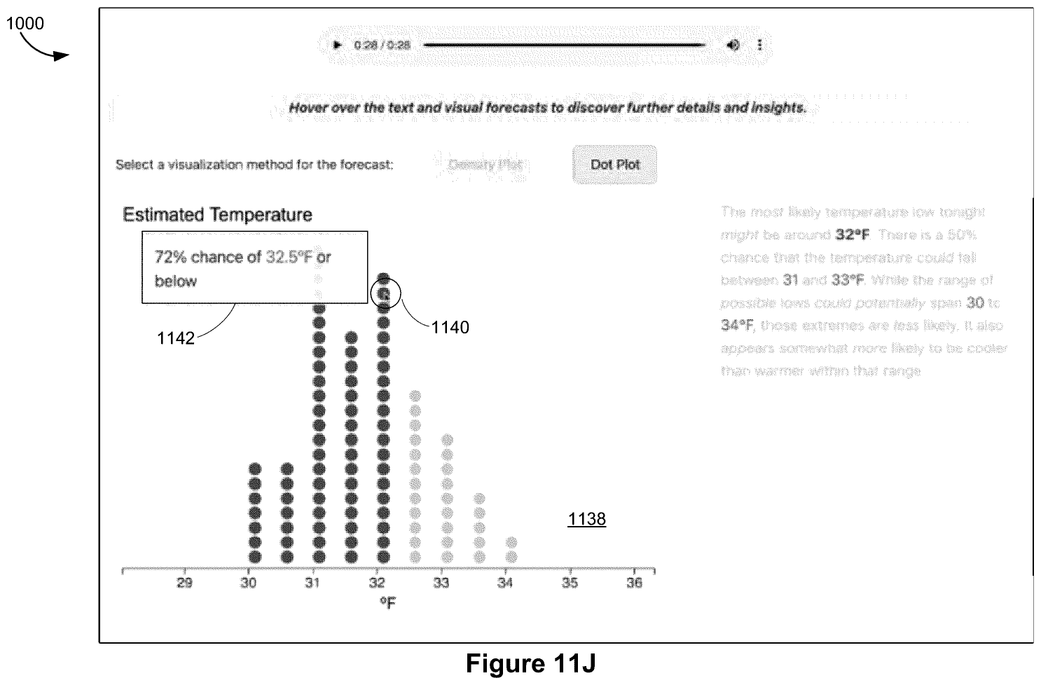

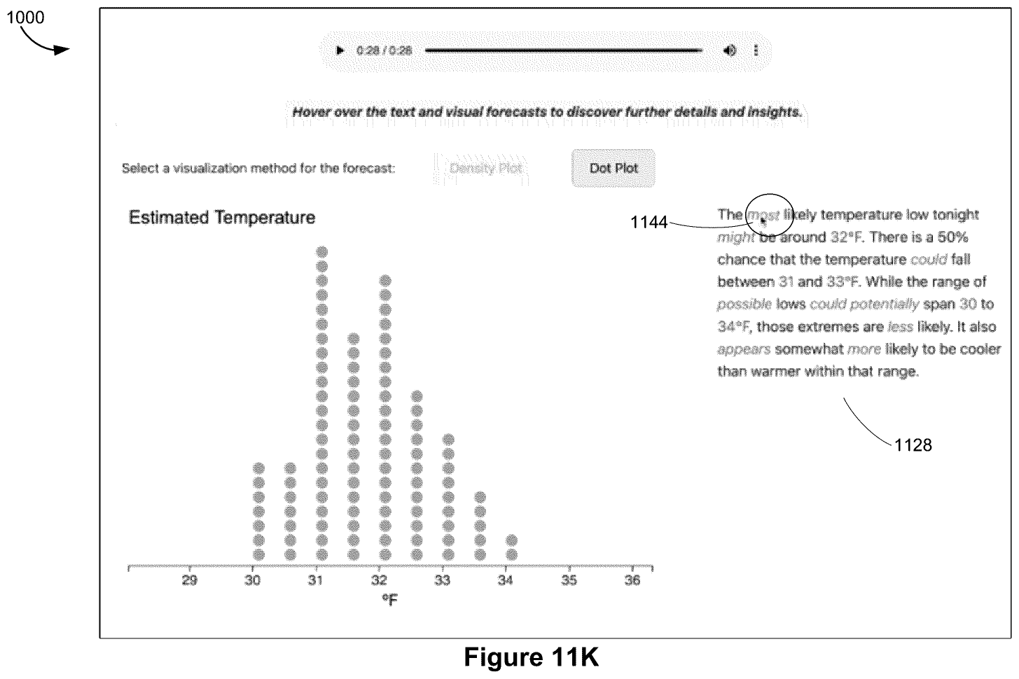

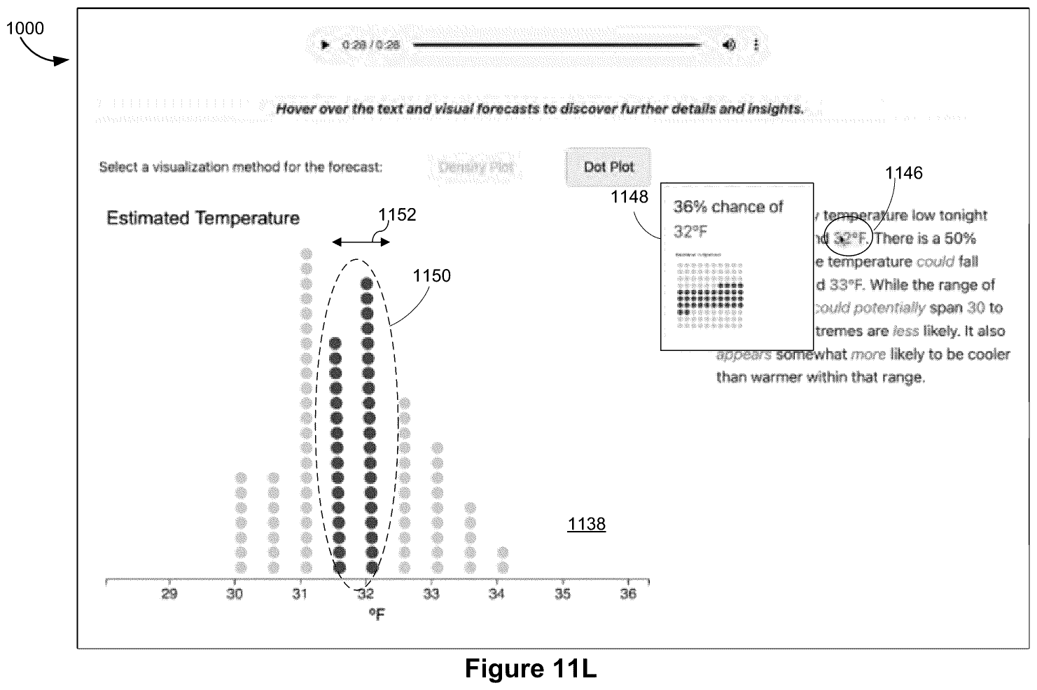

FIG. 8 depicts multimodal components and possible user interactions with passive and active interfaces, in accordance with some implementations. In some implementations, each of the passive and active interfaces employs visualizations, text descriptions with hedges, and speech elements with pauses and rate changes to convey data uncertainty. A computing device loads the interface and a user initiates playback. In some implementations, upon page load or a user interaction, a speech forecast begins to play. In some implementations, and as illustrated in the user interface screenshots in FIGS. 10A-10M and 11A-11L, the speech forecast is displayed at the top of the page, followed by a side-by-side D3 visualization and a textual description of uncertainty derived from a standardized natural language template containing hedge words, enriched with summary statistics from the dataset. An event listener in the interface continuously monitors time progression, triggering updates in the visualization and text modules during speech play. In some implementations, the color palette chosen for the prototypes is compliant with the WCAG AA guidelines for color contrast. In some implementations, the prototype systems employ a node.js client-server architecture.

In some implementations, the series of animations for both the text and visualization forecasts are timed according to the speech timestamp.

In some implementations, this process is the same for both the passive and active interface, although specific details of the animations can vary.

For example, the passive prototype has limited interaction. The end of the speech forecast triggered a final view of the visualization before all data faded from the page and was replaced with a replay button, and the forecast could be replayed to view and listen to the information again.

In some implementations, in the case of the active interface, the data can remain on display at the end of the speech forecast. The active prototype includes additional interactivity, such as detail-on-demand tooltips and animation, shown in FIG. 8. A user can hover over the chart or text elements to receive additional detail. For example, when a user hovers over a point in the visualization, the prototype highlights data points that are at or below the value of the point selected. Any text value that corresponds to the hovered value is bolded as well. Similarly, when a user hovers over a numerical descriptor within the text, the corresponding values are highlighted in the visualization. Stated another way, the active interface leverages interaction with the visual and textual modes, including additional linking between the two. Additionally, a tooltip appears displaying the likelihood of the specific temperature occurring, as well as an icon array showing this probability representation.

In some implementations, animations are employed to underscore the inherent uncertainty within the data. When a user interacts with the textual tooltip, the visualization adopts a subtle “wobble,” implemented in D3. Hedge words in the text also wobble on hover with slight rotation angles of −3° and 3°, coupled with a subtle 0.5 px blur effect. The user interface walkthrough for both the passive and active prototypes are described in FIGS. 10A-10M and 11A-11L.

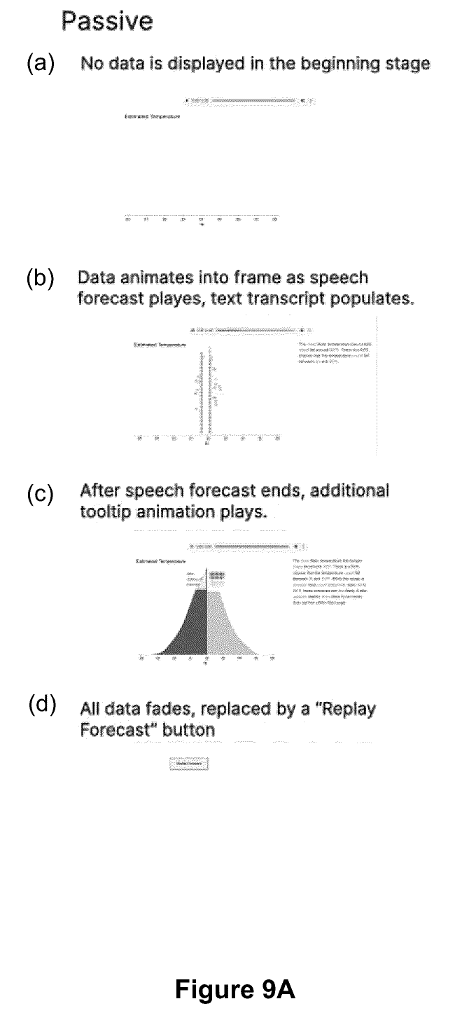

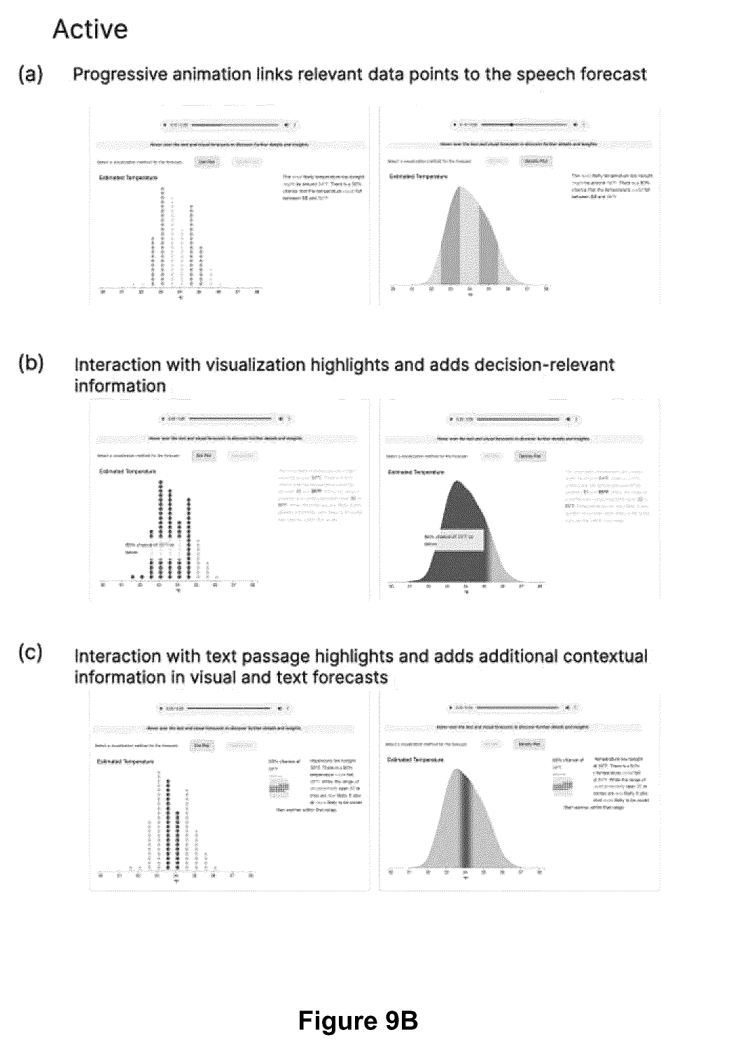

FIGS. 9A and 9B illustrate, respectively, screenshots of the passive interface and the active interface, in accordance with some implementations.

FIG. 9A shows that in some implementations, for the passive interface, (a) no data is displayed in the beginning stage; (b) data animates into the frame as the speech forecast plays and text transcript populates. In some implementations, (c) after the speech forecast ends, additional tooltip animation plays, and (d) a “Replay” button replaces the content in the interface.

FIG. 9B shows that in some implementations, for the active interface: (a) a progressive animation links relevant data points to the current speech forecast, (b) interaction with visualization highlights and adds decision-relevant information, and (c) Interaction with text passage highlights and adds additional contextual information in visual and text forecasts.

FIGS. 10A to 10M are screenshots illustrating a passive interface for communicating data uncertainty, in accordance with some implementations. FIGS. 11A to 11L are screenshots illustrating an active interface for communicating data uncertainty, in accordance with some implementations.

In the example of FIGS. 10 and 11, the multimodal representation describes a weather forecast depicting predicted temperature lows for a given evening. The interfaces in FIGS. 10 and 11 are situated in a decision-making context. In these examples, the user (e.g., the consumer of the multimodal data representation) assumes the role of a road maintenance company contracted to treat roads with salt to prevent icing. The user is tasked with applying salt to the roads when the temperature was at or below 32° F. (0° C.) to prevent ice from forming. The user is informed that salt supplies were limited, so maintenance companies must balance cost (and supply) with damage prevention. To make this decision, the user views and listens to a forecast depicting predicted temperature lows for a given evening. The appropriateness of a user's decision to salt the roads depends on the costs of salting and potential damages; information not provided in this scenario. The decision context was used to provide a situation of use for the interface rather than to assess rationality.

Although the examples in FIGS. 10 and 11 describe the hypothetical scenario of salting roads, it will be apparent to one of ordinary skill in the art that the passive and active interfaces disclosed herein, and their generation thereof, are equally applicable to any dataset containing variability.

Referring back to the example of FIGS. 10A to 10M, FIG. 10A shows a user interface 1000. In some implementations, the user interface 1000 includes an option 1002 that, when selected by a user, presents data uncertainty in a multimodal context via a passive prototype (e.g., passive interface). In some implementations, the user interface 1000 includes an option 1004 that, when selected by a user, presents data uncertainty in a multimodal context via an active prototype (e.g., active interface). In FIG. 10A, the computing device receives user selection of the option 1002.

FIG. 10B illustrates the passive prototype, in accordance with some implementations. The passive prototype is divided into three primary sections: a visualization animation section (e.g., region 1006), a speech section (e.g., region 1008), and a text transcript section (e.g., region 1010). The user can interact with the “Play” icon 1012 or the audio seek bar 1014 (e.g., speech seek bar) to initiate playback of the multimodal data representation. Once the data animation concludes, it highlights a decision-centric piece of information. In this scenario, it refers to the likelihood of freezing.

FIGS. 10C to 10L are screenshots displayed in the user interface 1000 in response to initiation of playback of the multimodal data representation.

As the audio content is presented, the text transcript section (e.g., region 1010) of the user interface 1000 displays a text transcript of the audio narrative that is time-synchronized with the audio narrative. As the audio content is presented, the visualization animation section (e.g., region 1006) displays an animated visualization that is also time-synchronized with the audio narrative. Stated another way, the audio, visual, and text modes of the multimodal representation are all time-synchronized with one another.

In some implementations, the text transcript is displayed sentence-by-sentence in the region 1010. For example, the transition from FIG. 10C to FIG. 10D corresponds to the computing device broadcasting the first sentence of the audio narrative (i.e., “The most likely temperature low tonight might be around 32 degrees Fahrenheit.”). As this sentence is broadcast, the user interface 1000 displays an animated graphic of dots 1017 entering from the top, falling (e.g., randomly) onto the axis 1016 of the data visualization 1018, and lining up (e.g., as columns of dots 1020 and 1022) on the axis 1016. The text transcript section (e.g., region 1010) displays the first sentence 1019 of the audio narrative. The first sentence 1019 includes hedge words 1024 (“most”) and 1026 (“might”) and includes a temperature value 1028 (e.g., a data value of a data field, such as “32° F.”).

In the example of FIGS. 10C and 10D, the hedge words 1024 and 1026 are displayed with a visual characteristic that is different from other text in the first sentence 1019. For example, in some implementations, the hedge words can be displayed with a color, font size, font type (e.g., italicized, bold or blur) or visual emphasis that is different from other text in the first sentence. In some implementations, the hedge words can be displayed with visual animation whereas the other text in the first sentence is static, non-animated text. In some implementations, the temperature value 1028 is displayed with visual characteristic that is different from other text in the first sentence 1019. For example, in some implementations, the temperature value 1028 can be displayed with a color, font size, font type (e.g., italicized, bold, or blur) or visual emphasis that is different from other text in the first sentence. In some implementations, the temperature value 1028 can be displayed with visual animation whereas the other text in the first sentence comprises static, non-animated text.

The transition from FIGS. 10E to 10F corresponds to the computing device broadcasting the second sentence of the audio narrative “There is a 50 percent chance that the temperature could fall between 31 and 33 degrees Fahrenheit.” As this sentence is broadcast, the user interface 1000 displays an animated graphic of dots 1030 entering from the top, falling onto the axis 1016 of the data visualization 1018, and lining up (e.g., as columns of dots 1032, 1034, and 1036 adjacent to the existing columns of dots 1020 and 1022) on the axis 1016. Similar to the example of FIGS. 10C and 10D, the hedge word 1038 (“could”) in the second sentence is displayed with a different visual characteristic compared to other text in the second sentence.

FIGS. 10G, 10H, and 10I are screenshots corresponding to the computing device broadcasting the third sentence of the audio narrative “While the range of possible lows could potentially span 30 to 34 degrees, those extremes are less likely.” The transition from FIGS. 10H and 10I show that after the columns of dots have lined up on the axis 1016, the user interface 1000 transitions from displaying a visualization 1018 that includes a distribution of dots to displaying a visualization 1040 that comprises a distribution curve.

FIGS. 10J and 10K are screenshots corresponding to the computing device broadcasting the last sentence of the audio narrative “It also appears slightly more likely to be warmer than cooler in that range.” FIG. 10J illustrates the animation visualization 1040 wobbling or swaying (1042) about the mean temperature. FIG. 10K shows that after the speech forecast ends, the user interface 1000 displays additional tooltip animation 1046 highlighting a decision-centric piece of information. In this scenario, it refers to the likelihood of freezing (e.g., “54% chance of freezing”).

FIG. 10L shows that in some implementations, at the conclusion of the playback of the multimodal representation, the user interface 1000 displays a “Replay” button 1048, which replaces the content in the interface. Users have the flexibility to replay the forecast if they wish. FIG. 10M illustrates that the users have the option to leverage the speech functionality (e.g., by interacting with the audio seek bar 1014) to transition between various animation states.

FIGS. 11A to 11N are screenshots illustrating an active interface for communicating data uncertainty, in accordance with some implementations. In some implementations, the active interface (e.g., active prototype) also follows the same general structure as the passive interface, with two distinct differences. First, the information remains persistently visible after the completion of the speech forecast. Second, the active interface offers enhanced interaction with both the visual and text data.

In FIG. 11A, the user selects option 1004 in the user interface 1000.

FIG. 11B shows that in some implementations, just like the passive interface, the active interface includes a visualization animation section (e.g., region 1006), a speech section (e.g., region 1008), and a text transcript section (e.g., region 1010). The user can interact with the “Play” icon 1012 or the audio seek bar 1014 (e.g., speech seek bar) to initiate playback of the multimodal data representation. In some implementations, the user interface 1000 includes a prompt 1102 for the user to select a visualization type (e.g., visualization method). The user interface 1000 includes an affordance 1104 (e.g., user-selectable interface element) corresponding to “density plot” (e.g., a probability density plot) and an affordance 1106 (e.g., user-selectable interface element) corresponding to “dot plot.” In the example of FIG. 11B, the affordance 1104, corresponding to “density plot,” is selected.

In FIG. 11B, the user interacts with the “Play” icon 1012 or the audio seek bar 1014 (e.g., speech seek bar) to initiate playback of the multimodal data representation. The computing device broadcasts (e.g., in a computer-generated voice) an audio narrative that recites “The most likely temperature low tonight might be around 32 degrees Fahrenheit. There is a 50 percent chance that the temperature could fall between 31 and 33 degrees Fahrenheit. While the range of possible lows could potentially span 30 to 34 degrees, those extremes are less likely. It also appears slightly more likely to be warmer than cooler in that range.”

FIG. 11B shows that as the computing device broadcasts the first sentence of the audio narrative (i.e., “The most likely temperature low tonight might be around 32 degrees Fahrenheit.”), the text transcript section 1010 concurrently (e.g., simultaneously) displays a text transcript 1108 corresponding to the first sentence of the audio narrative. As with the passive interface, the hedge words “most” and “might” and the data value (e.g., temperature value “32° F.) are displayed with different visual characteristics compared to the other text in the text transcript. The visualization animation section 1006 concurrently displays an animated visualization 1110, including visually emphasizing a portion 1112 of the visualization corresponding to the content described in the audio narrative and the text transcript.

FIG. 11C shows that as the computing device broadcasts the second sentence of the audio narrative (i.e., “There is a 50 percent chance that the temperature could fall between 31 and 33 degrees Fahrenheit.”), the text transcript section 1010 is simultaneous updated to display an updated text transcript 1113, corresponding to both the first and second sentences of the audio narrative. At the same time, the animated visualization 1110 visually emphasizes portions 1114 of the visualization 1110, corresponding to the content described in the second sentence of the audio narrative.

FIG. 11D shows that as the computing device broadcasts the third sentence of the audio narrative (i.e., “While the range of possible lows could potentially span 30 to 34 degrees Fahrenheit, those extremes are less likely.”), the text transcript section 1010 displays an updated text transcript 1115 that corresponds to the first, second, and third sentences of the audio narrative. The animated visualization 1110 visually emphasizes portions 1116 of the visualization 1110, corresponding to the content described in the third sentence of the audio narrative. FIG. 11E is a screenshot corresponding to the computing device broadcasting the last sentence of the audio narrative “It also appears somewhat more likely to be cooler than warmer within that range.”

As with the passive version, the audio seek bar 1014 serves as a tool to navigate between different animation phases. FIG. 11F illustrates a user interaction with the audio seek bar 1014, whereby the user changes the playing position by clicking or dragging a current position of the seek bar 1014 to position 1118. In response to the user interaction, the user interface updates the display of the visualization 1110 and the text transcript to a segment corresponding to the timestamp of the audio narrative.

In some implementations, a user can extract relevant decision information directly from the visualization. For example, FIG. 11G shows a user hovering a pointer (1120) over a portion of the visualization. In response to the user interaction, the user interface 1000 highlights a portion 1124 of the visualization (e.g., the portion to the left of the pointer) and displays a toolstrip 1122 with decision-relevant information (e.g., percentage change of the temperature being 31.5° F. or lower).

In some implementations, when a user hovers over numerical values, a tooltip emerges, displaying the percentage likelihood of the given temperature. This is illustrated in the example of FIG. 11H, which shows a user hovering a pointer (1126) over a temperature value of 32° F. on the transcript 1128. In response to the user interaction, the user interface 1000 displays a tooltip 1130 that displays the percentage likelihood of the temperature being 32° F. At the same time, the user interface 1000 visually highlights a portion 1132 (shown in purple) of the data visualization 1110, corresponding to the given temperature (32° F.). As disclosed herein, the tooltip 1130 not only offers a compact visualization for better clarity on probabilities, but also emphasizes the corresponding values in the main visual representation. In some implementations, the display of the tooltip 1130 also triggers an animation further emphasizing the data uncertainty. For example, in FIG. 11H, the data visualization 1110 rocks back and forth with respect to a vertical line 1134, in the direction indicated by arrows 1136.

In some implementations, a user can navigate between different visual formats. FIG. 11I illustrates user selection of the affordance 1106, corresponding to the “dot plot.” In response to the user selection of the affordance 1106, the user interface 1000 displays a data visualization 1138 (e.g., an animated visualization) corresponding to a dot plot. A dot plot, also known as a strip plot or dot chart, is a form of data visualization that comprises data points plotted as dots on a graph with an x- and y-axis. The number of dots in each column represents the number of data points for each value (in this case, each temperature value).

In FIG. 11J, when a user hovers over (1140) a dot on the visualization 1138, corresponding to a particular temperature (e.g., 32.5° F.), the user interface 1000 displays a tooltip 1142 that indicates a percentage chance that the forecasted temperature is that temperature or below.

FIG. 11K illustrates a user interaction (e.g., a hover over action 1144) with a hedge word “most” in the text transcript 1128. With the text content, hovering over hedge words applies a subtle blur and back and forth rocking motions, simulating a teeter-totter. FIG. 11K illustrates a subtle blur of the hedge word “might” under the cursor, with a slight rocking motion of the word “might”. This movement accentuates the element of uncertainty.

FIG. 11L shows that when a user hovers over (1146) a numerical value, corresponding to a given temperature (e.g., 32° F.), the user interface 1000 displays a tooltip 1148 that shows a percentage likelihood of the given temperature. This tooltip 1148 not only offers a compact visualization for better clarity on probabilities, but also emphasizes the corresponding values in the main visual representation 1138 and triggers an animation further emphasizing the data uncertainty. The vertical columns of dots 1150 sway back and forth, in the direction represented by arrow 1152.

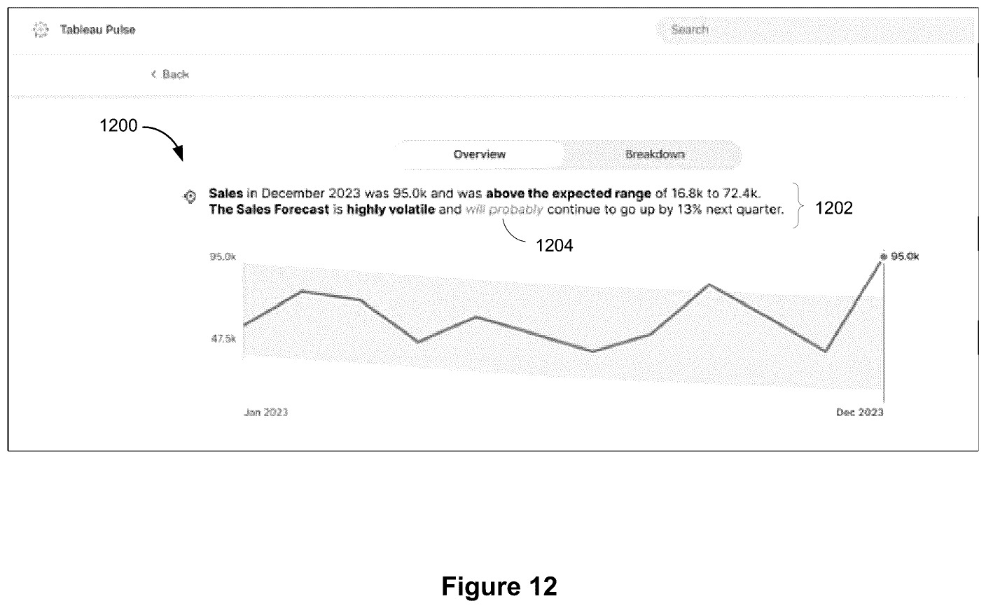

In some implementations, the principles for generating and presenting multimodal representations disclosed herein can be used to model and predict user engagement with different dashboards or reports in a feature like Tableau Pulse. For example, by analyzing historical user interaction data (e.g., frequency of use, time spent, or user roles), the algorithm can identify patterns in data with measures of its uncertainty. The data uncertainty can be used to recommend relevant dashboards and reports to users, enhancing their experience and efficiency. FIG. 12 illustrates a snapshot 1200 of a Tableau Pulse on sales metrics. Using the methods and algorithms disclosed herein, the computing device can compute the forecast for next quarter and display an insight summary 1202. The summary includes the text 1204 “will probably”, indicating the uncertainty for next quarter. If the insight summary is interactive, the text 1204 can wobble or blur upon hover to further communicate data uncertainty in the metric.

### Block Diagram

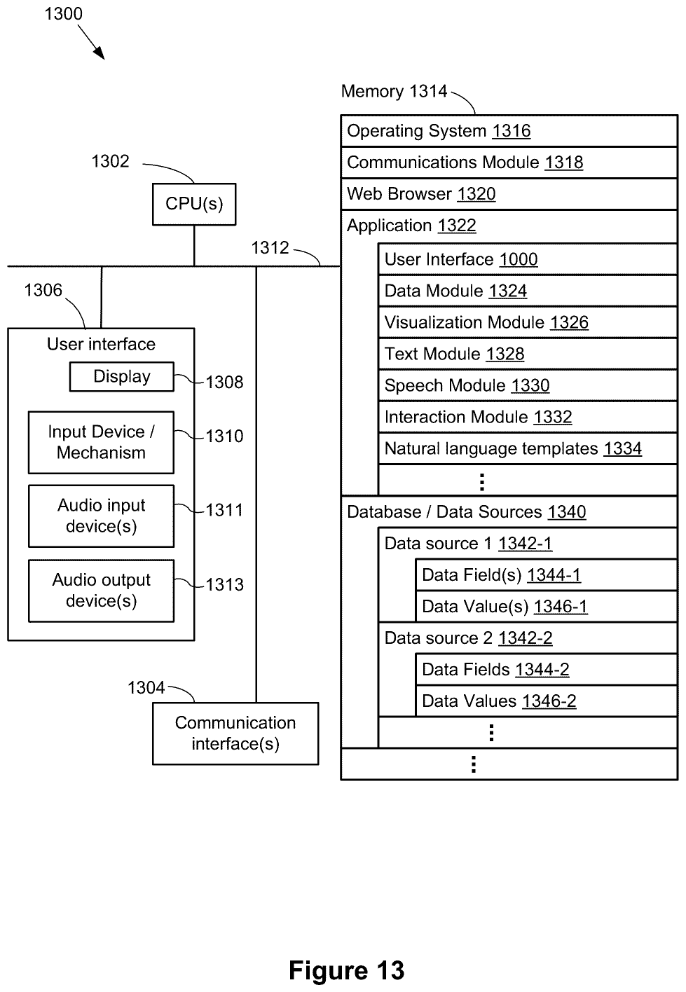

FIG. 13 is a block diagram of a computing device 1300, in accordance with some implementations. Various examples of the computing device 1300 include a desktop computer, a laptop computer, a tablet computer, a server computer, and other computing devices that have a processor capable of running an application 1322 for generating and/or displaying multimodal representations. The computing device 1300 typically includes one or more processing units/cores (CPUs) 1302 for executing modules, programs, and/or instructions stored in the memory 1314 and thereby performing processing operations; one or more network or other communications interfaces 1304; memory 1314; and one or more communication buses 1312 for interconnecting these components. The communication buses 1312 may include circuitry that interconnects and controls communications between system components.

The computing device 1300 optionally includes a user interface 1306 comprising a display device 1308 and one or more input devices or mechanisms 1310. In some implementations, the input device/mechanism 1310 includes a keyboard. In some implementations, the input device/mechanism 1310 includes a “soft” keyboard, which is displayed as needed on the display device 1308, enabling a user to “press keys” that appear on the display 1308. In some implementations, the display 1308 and input device/mechanism 1310 comprise a touch screen display (also called a touch sensitive display). In some implementations, the input device/mechanism 1310 includes a mouse. The user interface 1306 also includes audio output device(s) 1313, such as speakers or an audio output connection connected to speakers, earphones, or headphones. Furthermore, some computing devices use a microphone and voice recognition to supplement or replace the keyboard. In some implementations, the computing device 1300 includes audio input device(s) 1311 (e.g., a microphone) to capture audio (e.g., speech from a user)

In some implementations, the memory 1314 includes high-speed random-access memory, such as DRAM, SRAM, DDR RAM or other random-access solid-state memory devices. In some implementations, the memory 1314 includes non-volatile memory, such as one or more magnetic disk storage devices, optical disk storage devices, flash memory devices, or other non-volatile solid state storage devices. In some implementations, the memory 1314 includes one or more storage devices remotely located from the CPU(s) 1302. The memory 1314, or alternately the non-volatile memory device(s) within the memory 1314, comprises a non-transitory computer-readable storage medium. In some implementations, the memory 1314, or the computer-readable storage medium of the memory 1314, stores the following programs, modules, and data structures, or a subset thereof:
an operating system 1316, which includes procedures for handling various basic system services and for performing hardware dependent tasks;
a communications module 1318, which is used for connecting the computing device 1300 to other computers and devices via the one or more communication network interfaces 1304 (wired or wireless) and one or more communication networks, such as the Internet, other wide area networks, local area networks, metropolitan area networks, and so on;
a web browser 1320 (or other application capable of displaying web pages), which enables a user to communicate over a network with remote computers or devices;
an application 1322, which provides tools and the user interface 1000 for a user to generate, visualize, and/or interact with multimodal representations. In some embodiments, the application 1322 includes:
   a user interface 1000, which is described with respect to FIGS. 10A-10M and 11A-11L;
   a data module 1324. Because natural data tends to not always follow a normal distribution, in some implementations, the data module generates a more ecologically valid distribution by integrating raw distribution data from one or more datasets (e.g., databases/data sources 1340) a Node.js application using an Express framework, serving the dataset as a static file. Upon loading the prototype, a random trial is selected from the dataset. This selection process links the columns of the dataset file (e.g., a. csv file) to the unique trial number. In some implementations, dataset values in the .csv are derived by selecting 100 points from a normal distribution, such that the resulting distributions may not have been normally distributed. Text templates (e.g., natural language templates 1334) and timings also serve as a static JavaScript file, including each sentence and the timestamp it occurs in the speech element. A text-to-speech synthesis engine computes the timing information while generating speech from the SSML syntax. These timings are available as static files;
   a visualization module 1326 for generating the visualization aspect (e.g., mode or component) of the multimodal representation. In some implementations, the visualizations comprise animated visualizations. In some implementations, to communicate data uncertainty in visualizations, the visualization module 1326 generates density and 100-quantile dot plots. In some implementations, density plots are created using a kernel density estimator to determine the continuous probability curve from discrete data points. In some implementations, the quantile dot plot is created using a histogram, with 20 evenly spaced bins based on the range of the x-axis scale;
   a text module 1328 for generating text descriptions (e.g., mode or component) of the multimodal representation. In some implementations, the text descriptions correspond to text transcripts of the audio narratives. In some implementations, the text descriptions are generated with natural language templates 1334 containing hedges and summary statistics from the visualized dataset. The summary statistics can include the mean of the distribution, the range of the middle 50% of data, the full range of the data, and a verbal representation of distribution skew. The skew value is computed using the skewness function in R, then mapped to magnitudes (“slightly” to “significantly”) and a positive or negative direction, as described with respect to FIGS. 7A and 7B. Hedges were included in each sentence to communicate uncertainty (e.g., ‘might,’ ‘could’). In some implementations, the hedge words are algorithmically computed based on the variability and distribution of the data, as discussed with respect to FIGS. 7A and 7B. In some implementations, a standard black color can used to render the text, with a gray color (#757575) applied to hedges to indicate a higher level of uncertainty. Colors employed in the prototypes are compliant with the WCAG AA guidelines for color contrast;
   a speech module 1330 for generating and presenting speech content (e.g., audio narratives). In some implementations, the speech module 1330 translates the text templates into Google Speech Synthesis Markup Language (SSML) to provide adjustments in pitch, rate of speech, and pauses for communicating uncertainty. Because uncertainty is often reflected in acoustic characteristics such as pitch and intonation, to convey a speaker's doubt or hesitancy, in some implementations, the speech module 1330 adjusts the speech rate of hedge words such that it is lower than the rate of non-hedge words. For example, the speech rate of hedge words is 80%, 70%, or 60% of the speech rate of non-hedge rates. In some implementations, the speech module 1330 lowers the pitch of the hedge words compared to the pitch of non-hedge words (e.g., by 5%, 7%, or 10%). In some implementations, the speech module 1330 applies the same pitch treatment to numerical values, by slowing the speech corresponding to numerical values (e.g., to 70% or 80% compared to non-numerical and non-hedge words) and adding a pause (e.g., a 0.1 to 0.3-second break) before the values;
   an interaction module 1332, which facilitates user interaction with the passive and active prototypes (e.g., interfaces) as described with respect to FIGS. 8, 9A, 9B, 10A-10M, and 11A-11L. In both prototypes, the multimodal representation can be replayed to view and listen to the information. During the replay, the animated sequence for the text and visualization also repeats. The active prototype includes detail-on-demand tooltips and linking between modes, shown in FIG. 8. As discussed with reference to FIGS. 9A, 9B, 10A-10M, and 11A-11L, in some implementations, there are three distinct hover interactions (e.g., hedges, numerical values, visualization) that provide dynamic feedback and detailed insights about the data. For example, as described with reference to FIG. 11K, when a user hovers over a hedge word (e.g., the word “most likely”) in the text description, the word visually responds by “wobbling” at 3° angles and applying a 0.5 px blur effect. Hovering over a numerical value in the text shows a tooltip featuring an icon array visualizing the likelihood of the hovered number occurring within the dataset, as illustrated and described with reference to FIGS. 11H and 11L. Simultaneously, the corresponding section of the visualization that represents this number is highlighted and wobbles to draw attention and convey uncertainty. This is also described with reference to FIGS. 11H and 11L. Upon hovering over a mark in the visualization, a tooltip appears with a text description of the cumulative likelihood of achieving the corresponding value or lower, as illustrated and described with respect to FIGS. 11G and 11J.
one or more databases/data sources 1340, which are used by the application 1322. In some embodiments, the databases/data sources 1340 include a first data source 1342-1 (e.g., a first dataset) having data field(s) 1344-1 and data value(s) 1346-1 corresponding to the data field(s) 1344-1. In some embodiments, the databases/data sources 1340 include a second data source 1342-2 (e.g., a second dataset) having data field(s) 1344-2 and data value(s) 1346-2 corresponding to the data field(s) 1344-1.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1314 stores a subset of the modules and data structures identified above. Furthermore, the memory 1314 may store additional modules or data structures not described above.

Although FIG. 13 shows a computing device 1300, FIG. 13 is intended more as a functional description of the various features that may be present rather than as a structural schematic of the implementations described herein. In practice, and as recognized by those of ordinary skill in the art, items shown separately could be combined and some items could be separated.

### Flowcharts

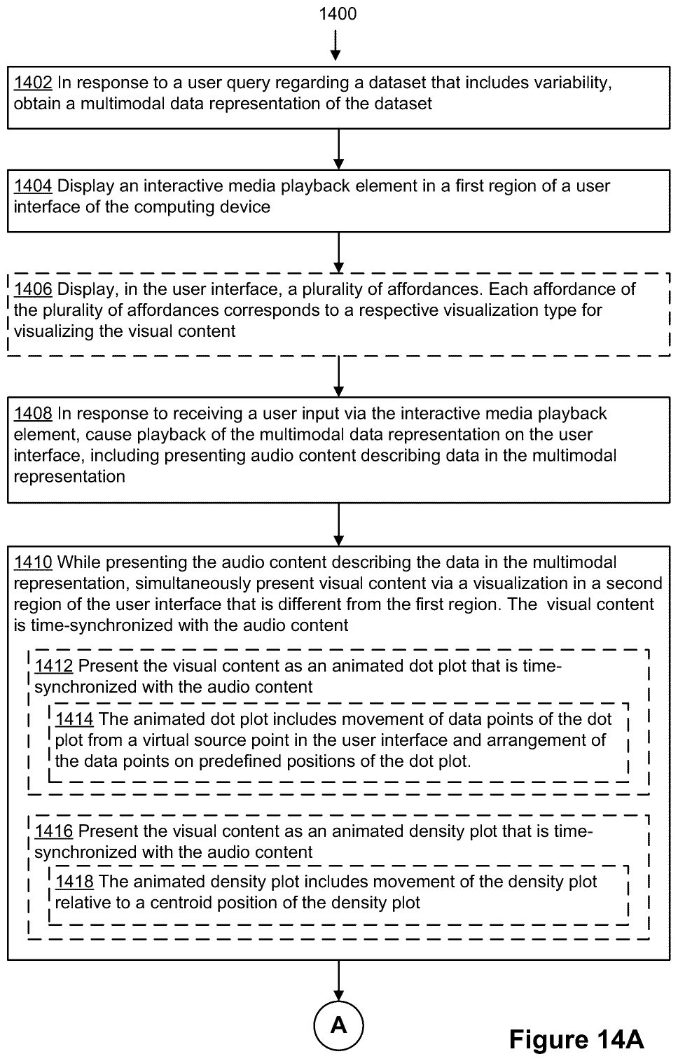

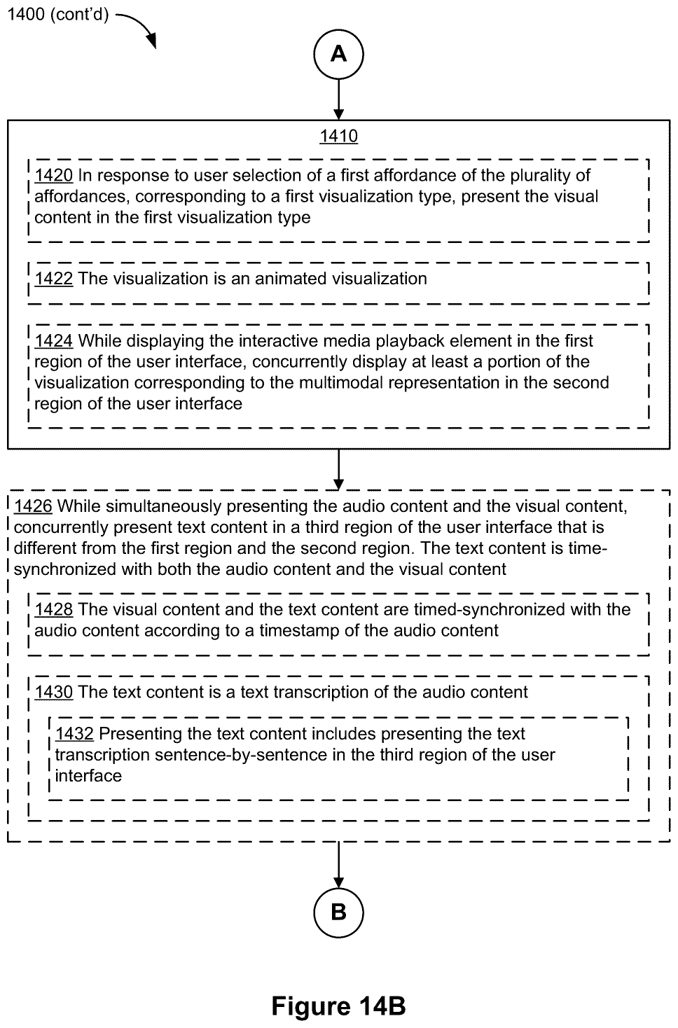

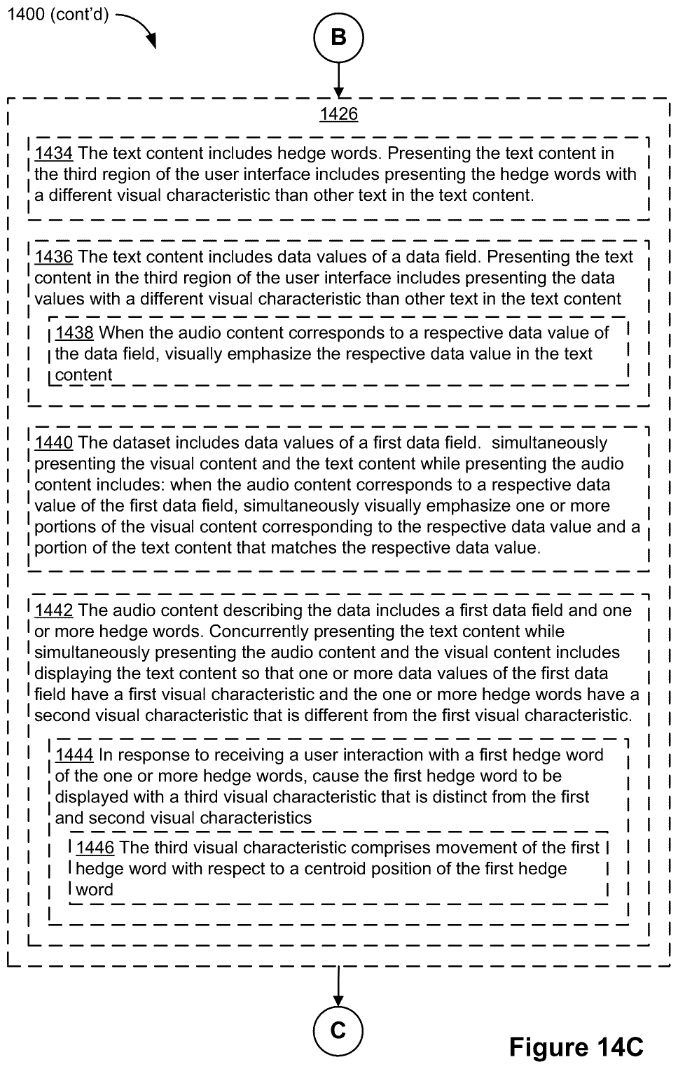

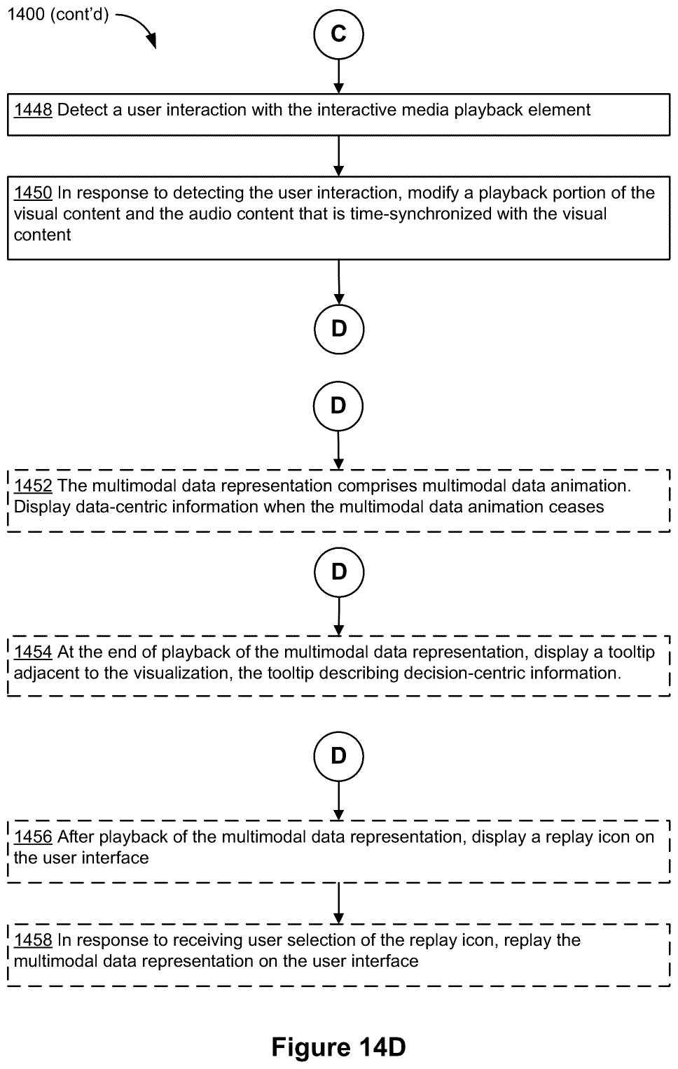

FIG. 14A-14D provide a flowchart of an example method 1400 for communicating data uncertainty, in accordance with some implementations. The method 1400 is performed at a computing system (e.g., the computing device 1300) having a display (e.g., display 1308), one or more processors (e.g., CPU(s) 1302), and memory (e.g., memory 1314). In some embodiments, the computing system comprises a computing device and a server system. In some embodiments, the method is performed using an application (e.g., application 1322, or a program, or other executable instructions). In some embodiments, the memory stores one or more programs configured for execution by the one or more processors. In some embodiments, the operations shown in FIGS. 1, 2, 3, 4, 5, 6, 7A, 7B, 8, 9A, 9B, 10A-10M, and 11A-11L correspond to instructions stored in the memory 1314 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1400 may be combined and/or the order of some operations may be changed. In some embodiments, some of the operations in the method 1400 may be combined with other operations in the method 1500.

The computing device, in response to a user query regarding a dataset that includes variability, obtains (1402) a multimodal data representation of the dataset.

In some implementations, the dataset that includes variability is a dataset with data uncertainty. In some implementations used herein, data uncertainty refers to a range of potential outcomes (e.g., has a distribution), variability within a dataset, or possible error in measurements or predictions. The multimodal data representation is used for presenting the dataset that includes data uncertainty. The multimodal data representation includes information about data uncertainty. In some implementations, the multimodal data representation includes an audio component (e.g., an audio mode), a text component (e.g., a text mode), and a visualization component (e.g., a visualization mode). In some implementations, each mode is linked to (e.g., time-synchronized with) the other modes, thereby creating an integrated interface experience for a user.

The computing device displays (1404) an interactive media playback element (e.g., “Play” icon 1012 or audio seek bar 1014) in a first region (e.g., region 1008) of a user interface (e.g., user interface 1000) of the computing device:

In some implementations, the computing device displays (1406), in the user interface, a plurality of affordances (e.g., user-selectable icons). For example, the plurality of affordances can include affordance 1104 and affordance 1106. Each affordance of the plurality of affordances corresponds to a respective visualization type for visualizing the visual content. For example, in some implementations, the visualization type is a density plot. In some implementations, the visualization type is a dot plot.

The computing device, in response to receiving a user input via the interactive media playback element (e.g., to initiate playback of the multimodal representation), causes (1408) playback of the multimodal data representation on the user interface, including presenting audio content (e.g., an audio narrative) describing data in the multimodal representation.

In some implementations, the computing device, while (e.g., simultaneously with, concurrently with) presenting the audio content, simultaneously presents (1410) visual content via a visualization in a second region (e.g., region 1006) of the user interface that is different from the first region. The visual content is timed-synchronized with the audio content. For example, the visual content can comprise computer-generated visual content or an animated visualization.

In some implementations, simultaneously presenting the visual content and the text content includes presenting (1412) the visual content as an animated dot plot that is time-synchronized with the audio content. This is illustrated in the examples of FIGS. 10C-10H and 11I-11L.

In some implementations, the data for the dot plot (and density plot) is derived from a CSV file containing one hundred points from a normal distribution. The dot plot is created using a histogram with 20 evenly spaced bins based on the x-axis scale range. This histogram forms the basis for the quantile dot plot, representing the distribution visually. An event listener monitors the speech module's time progression, triggering updates in both the visualization and text modules. This synchronization ensures that the animation aligns with the speech narration and the corresponding text descriptions. The dot plot animation is linked to the speech timestamp, enabling replay and interaction. Users can hover over chart elements to trigger tooltips and visual effects. The elements of the dot plot are appended to a scalable vector graphics (SVG) element when rendered on the multimodal representation.

In some implementations, the animated dot plot includes (1414) movement (e.g., from a predefined position at the top of the visualization, in a substantially vertical direction) of data points (e.g., dots) of the dot plot from a virtual source point in the user interface; and arrangement of the data points (e.g., as columns) on predefined positions of the dot plot. This is illustrated in the transition from FIGS. 10C to 10D. For example, the arrangement of the data points includes vertically stacking the data points (e.g., dots) as columns of dots. The arrangement of the dots on the dot plot visually and graphically depicts data trends or grouping such as central tendency, dispersion, skewness, and modality of the data.

In some implementations, simultaneously presenting the visual content and the text content includes presenting (1416) the visual content as an animated density plot that is time-synchronized with the computer-generated audio content.

In some implementations, the data for the density plot is derived from a CSV file containing a hundred points from a normal distribution. The density plot is implemented by computing the kernel density estimation of the data to process the data into density values. The elements of the density plot are appended to a SVG element when rendered on the multimodal representation.

In some implementations, the animated density plot includes (1418) movement (e.g., computer-generated movement, lateral motion, a back-and-forth swaying motion) of the density plot relative to a centroid position (e.g., axis) of the density plot. This is illustrated in FIG. 11H.

Referring to FIG. 14B, in some implementations, the method 1400 includes, in response to user selection of a first affordance of the plurality of affordances, corresponding to a first visualization type, presenting (1420) the visual content in the first visualization type. In some implementations, the first visualization type comprises a density plot. In some implementations, the first visualization type comprises a dot plot.

In some implementations, the visualization is (1422) an animated visualization. This is illustrated in the examples of FIGS. 10A-10M and 11A-11L.

In some implementations, the computing device, while displaying the interactive media playback element in the first region of the user interface, concurrently displays (1424) at least a portion of the visualization corresponding to the multimodal representation in the second region of the user interface.

In some implementations, the computing device, while simultaneously presenting the audio content and the visual content, concurrently presents (1426) text content in a third region (e.g., region 1010) of the user interface that is different from the first region and the second region. The text content is time-synchronized with both the audio content and the visual content. In some implementations, the text content comprises a text transcript that matches the audio content.

In some implementations, the visual content and the text content are (1428) timed-synchronized with the audio content according to a timestamp of (corresponding to) the audio content.

In some implementations, the text content is (1430) a text transcript of the audio content. In some implementations, the text content is synonymous with closed captioning, in that the text content displays the audio portion of the multimodal representation as text on the user interface, in a time-synchronized manner that reflects the audio track.

In some implementations, presenting the text content includes presenting (1432) the text transcript sentence-by-sentence in the third region of the user interface. In some implementations, presenting the text content includes presenting the text transcript word-by-word, or line-by-line. Stated another way, the text content is presented in a piecemeal fashion (as opposed to in its entirety).

With continued reference to FIG. 14C, in some implementations, the text content includes (1434) hedge words. In accordance with some implementations of the present disclosure, hedge words are words that convey vagueness, ambiguity, fuzziness, caution, and uncertainty. Some examples of hedge words include “may,” “might,” “possible,” “more likely,” “less likely,” “seems like”. In some implementations, presenting the text content in the third region of the user interface includes presenting the hedge words with a different visual characteristic than other text in the text content. The different visual characteristics can include a different font color, a different font size, a different font type, a different visual emphasis (e.g., italicized, bold, blur, highlight, or visual animation).

In some implementations, the text content includes (1436) data values (e.g., numerical numbers) of a data field. Presenting the text content in the third region of the user interface includes presenting the data values with a different visual characteristic (e.g., different font color, font size, font type, or visual effect (e.g., italicized, bold, highlight, or visual animation)) than other text in the text content.

In some implementations, when the audio content corresponds to a respective data value of the data field, the computing device visually emphasizes (1438) (e.g., bolds, highlights, visually animates. uses a different font size or font type) the respective data value in the text content.

In some implementations, the data includes (1440) data values of a first data field. For example, in the exemplary embodiments of FIGS. 10 and 11, the first data field can be “temperature” and the data values are temperature values such as “32 deg F.” and “30 deg F.” Simultaneously presenting the visual content and the text content while presenting the audio content includes: when the audio content corresponds to (e.g., recites) a respective data value of the first data field, simultaneously visually emphasizing: one or more portions of the visual content corresponding to the respective data value; and a portion of the text content that matches the respective data value.

In some implementations, the computer-generated audio content describing the first data includes (1442) a first data field (e.g., temperature) and one or more hedge words. Simultaneously presenting the computer-generated visual content and the computer-generated text content includes displaying one or more data values of the first data field with a first visual characteristic and displaying each of the one or more hedge words with a second visual characteristic that is distinct from the first visual characteristics. As an example, in some implementations, the computing device renders the non-hedge words a standard black color and renders hedge words with a gray color (#757575) to indicate a higher level of uncertainty.

In some implementations, in response to receiving a user interaction (e.g., mouse hover over action) with a first hedge word of the one or more hedge words, the computing device causes (1444) the first hedge word to be displayed with a third visual characteristic that is distinct from the first and second visual characteristics. For example, in some implementations, the first visual characteristic can be a different font size, the second visual characteristic can be a different font color, and the third visual characteristic can be a different font type. In some implementations, the third visual characteristic comprises a subtle blur, or a back-and-forth rocking motion, like a teeter-totter, as illustrated with reference to FIG. 11K.

In some implementations, the third visual characteristic comprises (1446) motion (e.g., a pivoting motion) of the first hedge word with respect to a centroid position of the first hedge word (e.g., a back-and-forth rocking motion resembling a teeter-totter, to accentuate the uncertainty).

For example, when a user hovers over a hedge word in the text description, the word visually responds by “wobbling” at 3° angles and applying a 0.5 px blur effect. Hovering over a numerical value in the text shows a tooltip featuring an icon array visualizing the likelihood of the hovered number occurring within the dataset. Simultaneously, the corresponding section of the visualization that represents this number is highlighted and wobbles to draw attention and convey data uncertainty.

Referring to FIG. 14D, the computing device detects (1448) a user interaction with the interactive media playback element. The computing device, in response to detecting the user interaction, modifies (1450) a playback portion (e.g., display) of the multimodal visualization and the audio content that is time-synchronized with the multimodal visualization.

In some implementations, the multimodal data representation comprises multimodal data animation. The method includes displaying (1452) data-centric information when the multimodal data animation ceases (e.g., concludes). (e.g., the data centric information includes the probability of an outcome, such as the likelihood of freezing)

In some implementations, the computing device, at the end (e.g., conclusion) of the multimodal data representation, displays (1454) a tooltip (e.g., a user interface element) adjacent to (e.g., overlaid on top of) the visualization, the tooltip describing decision-centric information. For example, FIG. 10K shows that after the multimodal representation for the temperature forecast concludes, the user interface 1000 displays additional tooltip animation highlighting a decision-centric piece of information corresponding to a likelihood of freezing (e.g., “54% chance of freezing”)

In some implementations, the computing device, after playback of the multimodal data representation, displays (1456) a replay icon (e.g., “Replay” button 1048) on the user interface. The computing device, in response to receiving user selection of the replay icon, replays (1458) the multimodal data representation on the user interface.

It should be understood that the particular order in which the operations in FIGS. 14A to 14D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 1500) are also applicable in an analogous manner to method 1400 described above with respect to FIGS. 14A to 14D.

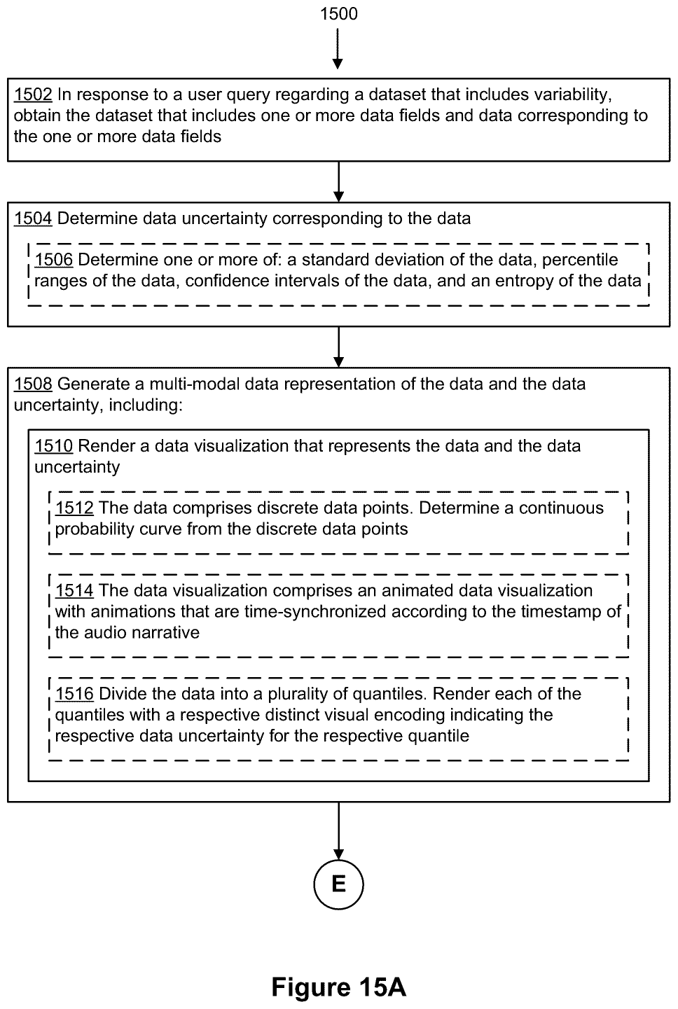

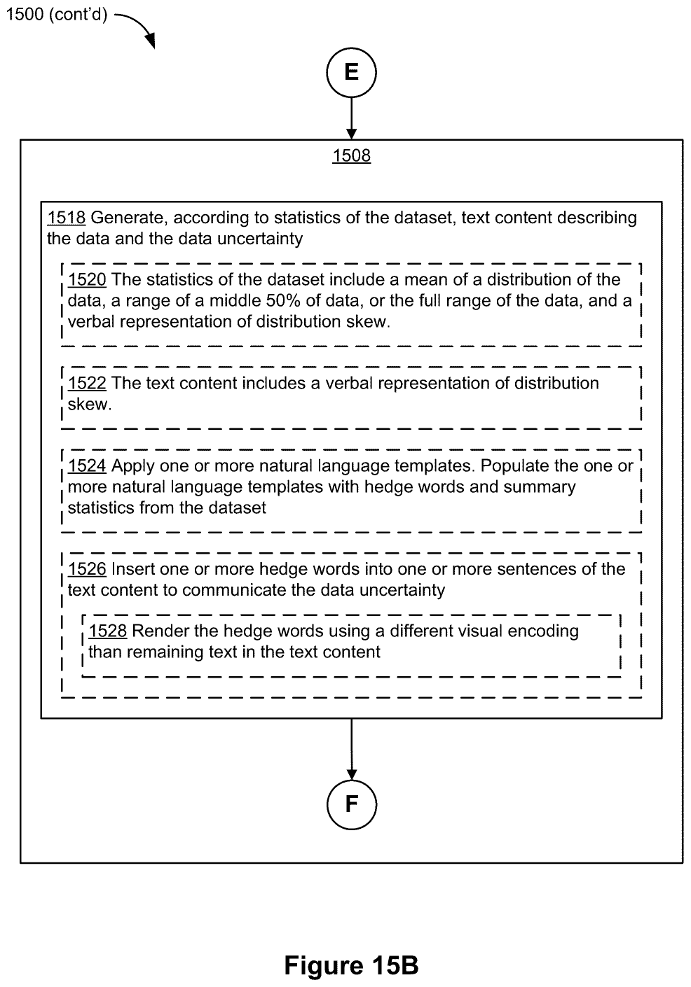

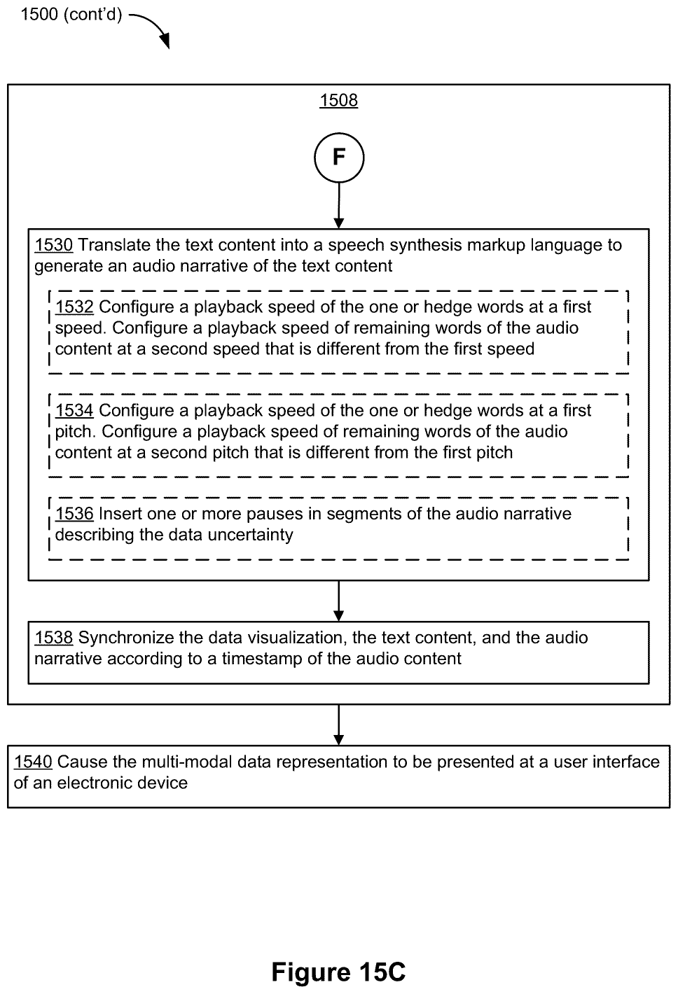

FIG. 15A-15C provide a flowchart of an example method 1500 for multimodal data representations, in accordance with some implementations. The method 1500 is performed at a computing system (e.g., the computing device 1300) having a display (e.g., display 1308), one or more processors (e.g., CPU(s) 1302), and memory (e.g., memory 1314). In some embodiments, the computing system comprises a computing device and a server system. In some embodiments, the method is performed using an application (e.g., application 1322, or a program, or other executable instructions). In some embodiments, the memory stores one or more programs configured for execution by the one or more processors. In some embodiments, the operations shown in FIGS. 1, 2, 3, 4, 5, 6, 7A, 7B, 8, 9A, 9B, 10A-10M, and 11A-11L correspond to instructions stored in the memory 1314 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1500 may be combined and/or the order of some operations may be changed. In some embodiments, some of the operations in the method 1500 may be combined with other operations in the method 1400.

The computing device, in response to a user query regarding a dataset that includes variability, obtains (1502) the dataset that includes one or more data fields and data (e.g., data values) corresponding to the one or more data fields. For example, in the example of FIGS. 10A-10M and 11A-11L, the one or more data fields include “temperature” and data corresponding to the data field includes temperature measurements or predicted temperature values for a given hour, day, week, month, or year.

The computing device determines (1504) data uncertainty corresponding to the data.

In some implementations, determining the data uncertainty corresponding to the data includes determining (1506) one or more of: a standard deviation of the data, percentile ranges of the data, confidence intervals of the data, and an entropy of the data.

The computing device generates (1508) a multimodal data representation of the data and the data uncertainty.

In some implementations, generating the multimodal data representation includes rendering (1510) a data visualization that represents the data and the data uncertainty.

In some implementations, the data comprises (1512) discrete data points. Generating the data visualization that represents the data and the data uncertainty includes determining (e.g., using a kernel density estimator) a continuous probability curve from discrete data points.

In some implementations, the data visualization comprises (1514) an animated data visualization with animations that are time-synchronized according to the timestamp of the audio narrative.

In some implementations, rendering the data visualization includes dividing (1516) the data into a plurality of quantiles; and rendering each of the quantiles with a respective distinct visual encoding (e.g., different styling or color) indicating the respective data uncertainty for the respective quantile.

Referring to FIG. 15B, in some implementations, generating the multimodal data representation includes generating (1518), according to statistics of the dataset, text content describing the data and the data uncertainty.

In some implementations, the statistics from the dataset include (1520) the mean of a distribution of the data, a range of a middle 50% of data, or the full range of the data.

In some implementations, the text content includes (1522) a verbal representation of distribution skew. For example, the computing device computes (e.g., determines) a skewness value using the skewness function in R and correlates the skewness value to a corresponding skewness magnitude (e.g., “slightly” to “significantly”) and a direction (e.g., positive or negative direction), as described with reference to FIG. 7A.

In some implementations, the computing device generates the text content by applying (1524) one or more natural language templates (e.g., natural language templates 1334) and populating the one or more natural language templates with hedge words and summary statistics from the dataset.

In some implementations, generating the text content includes inserting (1526) one or more hedge words into one or more sentences of the text content to communicate the data uncertainty. In some implementations, hedge words can be algorithmically computed based on the variability and distribution of the data using steps and algorithms described with reference to FIGS. 7A and 7B

In some implementations, generating the text content includes rendering (1528) the hedge words using a different visual encoding than remaining text in the text content.

With continued reference to FIG. 15C, in some implementations, generating the multimodal data representation includes translating (1530) the text content into a speech synthesis markup language to generate an audio narrative (e.g., speech, audio content) of the text content.

In some implementations, the computing device configures (1532) a playback speed of the one or hedge words at a first speed (e.g., rate) and configures a playback speed of remaining words of the audio content at a second speed that is different from the first speed. For example, the first speed is slower than the second speed.

In some implementations, the computing device configures (1534) a playback speed of the one or hedge words at a first pitch and configures a playback speed of remaining words of the audio content at a second pitch that is different from the first pitch.

In some implementations, the computing device inserts (1536) one or more pauses (e.g., 0.5-second to 1-second pauses) in segments of the audio narrative describing the data uncertainty.

For example, because uncertain speech tends to be associated with rising intonation, slower speech rate, and more frequent pauses, in some implementations, the computing device (e.g., via speech module 1330) translates the text templates into Google Speech Synthesis Markup Language (SSML) to provide adjustments in pitch, rate of speech, and pauses for communicating uncertainty.

In some implementations, where the text includes hedge words that indicate data uncertainty, the computing device modifies the speech to 60%, 70%, or 80% of the original rate.

In some implementations, where the text includes hedge words that indicate data uncertainty, the computing device lowers the pitch by 5%, 8%, 10% or 20% compared to a pitch for non-hedge words. A pitch pattern called a scoop pitch can show uncertainty. The pitch starts low, then quickly falls lower before coming back to the original low position. This pattern can be used to show surprise or uncertainty about specific information.

In some implementations, the computing device applies the same pitch treatment to numerical values (e.g., data values), slowing the speech to 60%, 70%, or 80% of the original rate compared to words that are not hedge words or not numerical values.

In some implementations, for numerical values, the computing device adds a pause (e.g., break) of 0.2 seconds, 0.3 seconds, or 0.5 seconds, before narrating the values.

In some implementations, generating the multimodal data representation includes synchronizing (1538) (e.g., time-synchronizing) the data visualization, the text content, and the audio narrative according to a timestamp of the audio content.

The computing device causes (1540) the multimodal data representation to be presented at a user interface of an electronic device. In some implementations, the electronic device is the computing device. In some implementations, the electronic device is distinct from the computing device.

It should be understood that the particular order in which the operations in FIGS. 15A to 15C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 1400) are also applicable in an analogous manner to method 1500 described above with respect to FIGS. 15A to 15C.

Turning now to some example embodiments.
(A1) In one aspect, a method of communicating data uncertainty is performed at a computing device having a display, one or more processors, and memory storing one or more programs configured for execution by the one or more processors. The method includes, in response to a user query regarding a dataset that includes variability: (a) obtaining a multimodal data representation of the dataset; (b) displaying an interactive media playback element in a first region of a user interface of the computing device: (c) in response to receiving a user input via the interactive media playback element, causing playback of the multimodal data representation on the user interface, including: (i) presenting audio content describing data in the multimodal representation; and (ii) while presenting the audio content describing the data in the multimodal representation, simultaneously presenting visual content via a visualization in a second region of the user interface that is different from the first region, wherein the visual content is time-synchronized with the audio content. The method includes (d) detecting a user interaction with the interactive media playback element; and (e) in response to detecting the user interaction, modifying a playback portion of the multimodal visualization and the audio content that is time-synchronized with the multimodal visualization.
(A2) In some implementations of A1, the method includes, while simultaneously presenting the audio content and the visual content, concurrently presenting text content in a third region of the user interface that is different from the first region and the second region. The text content is time-synchronized with both the audio content and the visual content.
(A3) In some implementations of A2, the visual content and the text content are timed-synchronized with the audio content according to a timestamp of the audio content.
(A4) In some implementations of A2 or A3, the text content is a text transcript of the audio content.
(A5) In some implementations of A4, presenting the text content includes presenting the text transcript sentence-by-sentence in the third region of the user interface.
(A6) In some implementations of any of A2-A5, the text content includes hedge words. Presenting the text content in the third region of the user interface includes presenting the hedge words with a different visual characteristic than other text in the text content.
(A7) In some implementations of any of A2-A6, the text content includes data values of a data field; and presenting the text content in the third region of the user interface includes presenting the data values with a different visual characteristic than other text in the text content.
(A8) In some implementations of A7, the method includes: when the audio content corresponds to a respective data value of the data field, visually emphasizing the respective data value in the text content.
(A9) In some implementations of any of A1-A8, simultaneously presenting the visual content while presenting the audio content includes presenting the visual content as an animated dot plot that is time-synchronized with the audio content.
(A10) In some implementations of A9, the animated dot plot includes movement of data points of the dot plot from a virtual source point in the graphical user interface; and arrangement of the data points on predefined positions of the dot plot.
(A11) In some implementations of any of A2-A10, simultaneously presenting the visual content while presenting the audio content includes presenting the visual content as an animated density plot that is time-synchronized with the audio content.
(A12) In some implementations of A11, the animated density plot includes movement of the density plot relative to a centroid position of the density plot.
(A13) In some implementations of any of A2-A12, the data includes data values of a first data field; and simultaneously presenting the visual content and the text content while presenting the audio content includes: when the audio content corresponds to a respective data value of the first data field, simultaneously visually emphasizing: (i) one or more portions of the visual content corresponding to the respective data value and (ii) a portion of the text content that matches the respective data value.
(A14) In some implementations of any of A1-A13, the method includes, prior to causing playback of the multimodal data representation on the user interface, displaying, in the user interface, a plurality of affordances. Each affordance of the plurality of affordances corresponds to a respective visualization type for visualizing the visual content. The method includes: in response to user selection of a first affordance of the plurality of affordances, corresponding to a first visualization type, presenting the visual content in the first visualization type.
(A15) In some implementations of any of A2-A14, the audio content describing the data includes a first data field and one or more hedge words. Concurrently presenting the text content while simultaneously presenting the audio content and the visual content includes displaying the text content so that one or more data values of the first data field have a first visual characteristic and the one or more hedge words have a second visual characteristic that is different from the first visual characteristic.
(A16) In some implementations of A15, the method includes, in response to receiving a user interaction with a first hedge word of the one or more hedge words, causing the first hedge word to be displayed with a third visual characteristic that is distinct from the first and second visual characteristics.
(A17) In some implementations of A16, the third visual characteristic comprises movement of the first hedge word with respect to a centroid position of the first hedge word.
(A18) In some implementations of any of A1-A17, the multimodal data representation comprises multimodal data animation. The method includes displaying data-centric information when the multimodal data animation ceases.
(A19) In some implementations of any of A1-A18, the method includes, at the end of playback of the multimodal data representation, displaying a tooltip adjacent to the visualization, the tooltip describing decision-centric information.
(A20) In some implementations of any of A1-A19, the method includes: after playback of the multimodal data representation, displaying a replay icon on the user interface; and in response to receiving user selection of the replay icon, replaying the multimodal data representation on the user interface.
(A21) In some implementations of any of A1-A20, the visualization is an animated visualization.
(A22) In some implementations of any of A1-A21, the method includes, while displaying the interactive media playback element in the first region of the user interface, concurrently displaying at least a portion of the visualization corresponding to the multimodal representation in the second region of the user interface.
(B1) In another aspect, a method for generating multimodal data representations is performed at a computing device having a display, one or more processors, and memory. The memory stores one or more programs configured for execution by the one or more processors. The method includes, in response to a user query regarding a dataset that includes variability: (a) obtaining the dataset that includes one or more data fields and data corresponding to the one or more data fields; (b) determining data uncertainty corresponding to the data; (c) generating a multimodal data representation of the data and the data uncertainty, including: (i) rendering a data visualization that represents the data and the data uncertainty; (ii) generating, according to statistics of the dataset, text content describing the data and the data uncertainty; (iii) translating the text content into a speech synthesis markup language to generate an audio narrative of the text content; and (iv) synchronizing the data visualization, the text content, and the audio narrative according to a timestamp of the audio content. The method also includes (d) causing the multimodal data representation to be presented at a user interface of an electronic device.
(B2) In some implementations of B1, determining the data uncertainty corresponding to the data includes determining one or more of: a standard deviation of the data, percentile ranges of the data, confidence intervals of the data, and an entropy of the data.
(B3) In some implementations of B1 or B2, the data comprises discrete data points. Rendering the data visualization that represents the data and the data uncertainty includes determining a continuous probability curve from the discrete data points.
(B4) In some implementations of any of B1-B3, the data visualization comprises an animated data visualization with animations that are time-synchronized according to the timestamp of the audio narrative.
(B5) In some implementations of any of B1-B4, rendering the data visualization includes (i) dividing the data into a plurality of quantiles; and (ii) rendering each of the quantiles with a respective distinct visual encoding indicating the respective data uncertainty for the respective quantile.
(B6) In some implementations of any of B1-B5, the statistics of the dataset include the mean of a distribution of the data, a range of a middle 50% of data, the full range of the data, and a verbal representation of distribution skew.
(B7) In some implementations of any of B1-B6, generating the text content includes (i) applying one or more natural language templates; and (ii) populating the one or more natural language templates with hedge words and summary statistics from the dataset.
(B8) In some implementations of any of B1-B7, generating the text content includes inserting one or more hedge words into one or more sentences of the text content to communicate the data uncertainty.
(B9) In some implementations of B8, generating the text content includes rendering the hedge words using a different visual encoding than remaining text in the text content.
(B10) In some implementations of B8 or B9, generating the audio narrative includes: (i) configuring a playback speed of the one or hedge words at a first speed (e.g., rate); and (ii) configuring a playback speed of remaining words of the audio content at a second speed that is different from the first speed.
(B11) In some implementations of any of B8-B10, generating the audio narrative includes: (i) configuring a playback speed of the one or hedge words at a first pitch; and (ii) configuring a playback speed of remaining words of the audio content at a second pitch that is different from the first pitch.
(B12) In some implementations of any of B1-B11, wherein generating the audio narrative includes inserting one or more pauses in segments of the audio narrative describing the data uncertainty.
(C1) In one aspect, some embodiments include a system comprising one or more processors and memory that is in communication with the one or more processors. The memory stores instructions for performing the method of A1-A16 or B1-B2.
(D1) In one aspect, some embodiments include a non-transitory computer-readable storage medium including instructions that, when executed by a computing system, cause the computing system to perform the method of any of A1-A16 or B1-B2.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for generating multi-modal data representations, comprising:
at a computing device having a display, one or more processors, and memory storing one or more programs configured for execution by the one or more processors:
in response to a user query regarding a dataset that includes variability:
obtaining the dataset that includes one or more data fields and data corresponding to the one or more data fields;
determining data uncertainty corresponding to the data;
generating a multi-modal data representation of the data and the data uncertainty, including:
rendering a data visualization that represents the data and the data uncertainty;
generating, according to statistics of the dataset, text content describing the data and the data uncertainty;
translating the text content into a speech synthesis markup language to generate an audio narrative of the text content; and
synchronizing the data visualization, the text content, and the audio narrative according to a timestamp of the audio narrative; and
causing the multi-modal data representation to be presented at a user interface of an electronic device.

2. The method of claim 1, wherein determining the data uncertainty corresponding to the data includes determining one or more of: a standard deviation of the data, percentile ranges of the data, confidence intervals of the data, and an entropy of the data.

3. The method of claim 1, wherein:
the data comprises discrete data points; and
generating the data visualization that represents the data and the data uncertainty includes determining a continuous probability curve from discrete data points.

4. The method of claim 1, wherein the data visualization comprises an animated data visualization with animations that are time-synchronized according to the timestamp of the audio narrative.

5. The method of claim 1, wherein rendering the data visualization includes:
dividing the data into a plurality of quantiles; and
rendering each of the quantiles with a respective distinct visual encoding indicating the respective data uncertainty for the respective quantile.

6. The method of claim 1, wherein the statistics from the dataset include an average of a distribution of the data, a range of a middle 50% of data, a full range of the data, and a verbal representation of distribution skew.

7. The method of claim 1, wherein generating the text content includes:
applying one or more natural language templates; and
populating the one or more natural language templates with hedge words and summary statistics from the dataset.

8. The method of claim 1, wherein generating the text content includes inserting one or more hedge words into one or more sentences of the text content to communicate the data uncertainty.

9. The method of claim 8, wherein generating the text content includes rendering the hedge words using a different visual encoding than remaining text in the text content.

10. The method of claim 8, wherein generating the audio narrative includes:
configuring a playback speed of the one or hedge words at a first speed; and
configuring a playback speed of remaining words of the audio narrative at a second speed that is different from the first speed.

11. The method of claim 8, wherein generating the audio narrative includes:
configuring a playback speed of the one or hedge words at a first pitch; and
configuring a playback speed of remaining words of the audio narrative at a second pitch that is different from the first pitch.

12. The method of claim 1, wherein generating the audio narrative includes inserting one or more pauses in segments of the audio narrative describing the data uncertainty.

13. A computing device, comprising:
a display;
one or more processors; and
memory coupled to the one or more processors, the memory storing one or more programs configured for execution by the one or more processors, the one or more programs including instructions for:
in response to a user query regarding a dataset that includes variability:
obtaining the dataset that includes one or more data fields and data corresponding to the one or more data fields;
determining data uncertainty corresponding to the data;
generating a multi-modal data representation of the data and the data uncertainty, including:
rendering a data visualization that represents the data and the data uncertainty;
generating, according to statistics of the dataset, text content describing the data and the data uncertainty;
translating the text content into a speech synthesis markup language to generate an audio narrative of the text content; and
synchronizing the data visualization, the text content, and the audio narrative according to a timestamp of the audio narrative; and
causing the multi-modal data representation to be presented at a user interface of an electronic device.

14. The computing device of claim 13, wherein the instructions for determining the data uncertainty corresponding to the data include instructions for determining one or more of: a standard deviation of the data, percentile ranges of the data, confidence intervals of the data, and an entropy of the data.

15. The computing device of claim 13, wherein:
the data comprises discrete data points; and
the instructions for generating the data visualization that represents the data and the data uncertainty include instructions for determining a continuous probability curve from discrete data points.

16. The computing device of claim 13, wherein the instructions for rendering the data visualization include instruction for:
dividing the data into a plurality of quantiles; and
rendering each of the quantiles with a respective distinct visual encoding indicating the respective data uncertainty for the respective quantile.

17. A non-transitory computer-readable medium storing one or more programs configured for execution by one or more processors of a computing device, the one or more programs comprising instructions for:
in response to a user query regarding a dataset that includes variability:
obtaining the dataset that includes one or more data fields and data corresponding to the one or more data fields;
determining data uncertainty corresponding to the data;
generating a multi-modal data representation of the data and the data uncertainty, including:
rendering a data visualization that represents the data and the data uncertainty;
generating, according to statistics of the dataset, text content describing the data and the data uncertainty;
translating the text content into a speech synthesis markup language to generate an audio narrative of the text content; and
synchronizing the data visualization, the text content, and the audio narrative according to a timestamp of the audio narrative; and
causing the multi-modal data representation to be presented at a user interface of an electronic device.

18. The non-transitory computer-readable medium of claim 17, wherein the instructions for generating the text content include instructions for:
inserting one or more hedge words into one or more sentences of the text content to communicate the data uncertainty.

19. The non-transitory computer-readable medium of claim 18, wherein the instructions for generating the audio narrative include instructions for:
configuring a playback speed of the one or hedge words at a first speed; and
configuring a playback speed of remaining words of the audio narrative at a second speed that is different from the first speed.

20. The non-transitory computer-readable medium of claim 18, wherein the instructions for generating the audio narrative include instructions for:
configuring a playback speed of the one or hedge words at a first pitch; and
configuring a playback speed of remaining words of the audio narrative at a second pitch that is different from the first pitch.
